(19) United States
(12) Patent Application Publication
(10) Pub. No.: US 2026/0267918 A1
(43) Pub. Date: Sep. 10, 2026

(54) GRAPH-BASED MODELS WITH TAGS

(71) Applicant: Infosys Limited, Bangalore (IN)

(72) Inventor: Steven SCHILDERS, Columbus, IN (US)

(73) Assignees: Infosys Limited, Bangalore (IN); InvertIT Inc., Columbus, IN (US)

(21) Appl. No.: 19/069,924

(22) Filed: Mar. 4, 2025

(51) Int. Cl. G06F 16/901

(52) U.S. Cl. CPC G06F 16/9024

(57) ABSTRACT

An overlay system is provided that includes a storage element and processing circuitry coupled thereto. The storage element stores an executable graph-based model that includes a plurality of active nodes associated with a plurality of tag overlay nodes. Each active node has a set of tags with each tag indicating an execution criterion. The processing circuitry receives a stimulus and identifies a first active node and a first tag overlay node associated therewith. The processing circuitry determines a first tag of a set of tags associated with the first active node. The first tag has a tag type that matches a tag overlay node-type of the first tag overlay node. The processing circuitry executes an operation based on the first active node and the first tag overlay node and in conformity with a first execution criterion indicated by the first tag.

### FIELD OF THE DISCLOSURE

Various embodiments of the present disclosure relate generally to graph-based models. More specifically, various embodiments of the present disclosure relate to implementation tags in executable graph-based models with simulated nodes.

### BACKGROUND

Graph-based models have become increasingly popular and find applications in a wide variety of domains, including computer networks, social networks, transportation systems, and biological systems. These models rely on the representation of data as nodes and edges, where nodes can represent entities (e.g., edge nodes, vertex nodes) and edges denote the relationships between these entities. This flexibility and expressiveness make graph-based models a powerful tool for modeling complex systems.

In advanced graph-based systems, nodes are often extended or enhanced through the use of associated overlay nodes. Overlay nodes include specialized processing logic that, when executed, performs specific functionalities tied to their associated nodes. However, challenges arise when this processing logic is required to operate on only a specific portion of the associated node while excluding the remaining portions. This complexity increases the intricacy of overlay node design, making their implementation complicated. This is particularly problematic in environments with limited resources, where efficiency and simplicity are critical.

In light of the foregoing, there exists a need for a technical and reliable solution that overcomes the abovementioned problems.

Limitations and disadvantages of conventional and traditional approaches will become apparent to one of skill in the art, through the comparison of described systems with some aspects of the present disclosure, as set forth in the remainder of the present application and with reference to the drawings.

### SUMMARY

Methods and systems for facilitating application of tags and tag overlay nodes in executable graph-based models are provided substantially as shown in, and described in connection with, at least one of the figures.

Methods and systems disclosed herein facilitate implementation of tags and tag overlay nodes in an executable graph-based model and various operations associated with such implementation of the implementation of the tags and tag overlay nodes. The methods and systems disclosed herein include various operations performed by processing circuitry of an overlay system that includes the executable graph-based modes. Examples of the processing circuitry may include, but are not limited to a controller module, a transaction module, a data management module, a simulation management module, and an overlay management module, any other element of an overlay system, or a combination of two or more elements of the overlay system). The systems disclosed herein include a storage element that is configured to store the executable graph-based model that includes a plurality of active nodes associated with a plurality of tag overlay nodes. Each active node, of the plurality of active nodes, has a set of tags associated therewith, with each tag of the set of tags indicating an execution criterion for a tag overlay node of the plurality of tag overlay nodes. The storage element is coupled with the processing circuitry of the overlay system. The processing circuitry is configured to receive a first stimulus associated with the overlay system. The processing circuitry is further configured to identify, based on the first stimulus, a first active node of the plurality of active nodes. The processing circuitry is further configured to determine a first tag overlay node-type of a first tag overlay node, of the plurality of tag overlay nodes, associated with the first active node. The processing circuitry is further configured to determine a first tag of a first set of tags associated with the first active node. The first tag has a first tag type that matches the first tag overlay node-type of the first tag overlay node. The processing circuitry is further configured to execute, in response to the first stimulus, a first operation based on the first active node and the first tag overlay node. The execution of the first operation conforms with a first execution criterion indicated by the first tag.

In some embodiments, the first operation is executed further based on a tag configuration associated with the first tag. The tag configuration is indicative of an operational technique associated with the first tag overlay node.

In some embodiments, the first tag overlay node-type of the first tag overlay node is determined based on the first operation conforming to processing logic associated with the first tag overlay node.

In some embodiments, based on the identification of the first active node and the determination of the first tag overlay node-type of the first tag overlay node, the processing circuitry is further configured to retrieve the first set of tags associated with the first active node. The processing circuitry is further configured to compare the first tag overlay node-type of the first tag overlay node with a tag type of each tag of the first set of tags to determine the first tag. The first tag is determined based on the first tag type being a match to the first tag overlay node-type.

In some embodiments, the association of each tag of the first set of tags with the first active node is at least one of a group consisting of (i) a node level association or (ii) a node element level association.

In some embodiments, the first tag overlay node includes an implementation logic that corresponds to a pre-execution task associated with the first tag overlay node. To determine the first tag, the processing circuitry is further configured to execute the implementation logic of the first tag overlay node. The processing circuitry is further configured to compare, based on the execution of the implementation logic, the first tag overlay node-type of the first tag overlay node with a tag type of each tag of the first set of tags to determine the first tag having the first tag type that matches the first tag overlay node-type.

In some embodiments, the first active node is further associated with a tag container that stores the first set of tags.

In some embodiments, the first active node includes a plurality of node elements, and the first tag is associated with one or more node elements of the plurality of node elements. The first operation is executed further based on the one or more node elements.

In some embodiments, the first tag is one of a group consisting of a stateful tag or a stateless tag.

In some embodiments, based on the first tag being the stateful tag, an output of the first operation persists in the storage element upon an unloading of the first tag from the executable graph-based model.

In some embodiments, based on the first tag being the stateless tag, the output of the first operation ceases to persist in the storage element upon an unloading of the first tag from the executable graph-based model.

In some embodiments, the association of the first tag with the first active node is a node level association. The first active node further has a node element level association with a second tag of the first set of tags. The second tag is associated with a first node element of a plurality of node elements of the first active node. The second tag has the first tag type and is indicative of a second execution criterion. The first operation is executed further based on the first node element and in conformity with the second execution criterion.

In some embodiments, the first tag inherits from a third tag of the first set of tags.

In some embodiments, the first tag inherits from a fourth tag associated with a second active node of the plurality of active nodes.

In some embodiments, based on a loading of the first active node in the executable graph-based model, the processing circuitry is further configured to load the second active node in the executable graph-based model.

In some embodiments, the association of the first tag with the first active node is a node level association. The first active node includes a plurality of node elements. A second node element of the plurality of node elements has an absence of an associated tag with the first tag type. Based on the absence of the associated tag with the first tag type with the second node element, the processing circuitry is configured to associate the first tag with the second node element. The first operation is executed further based on the second node element.

In some embodiments, based on the first tag being a stateful tag, the processing circuitry is further configured to create a clone of the first tag and associate the clone of the first tag with the second node element.

In some embodiments, based on the first tag being a stateless tag, the processing circuitry is further configured to integrate a reference to the first tag in the second node element.

In some embodiments, prior to the execution of the first operation, the processing circuitry is further configured to determine whether at least one of a group consisting of the first active node or the first tag overlay node is loaded in the executable graph-based model. The processing circuitry is further configured to load, based on at least one of the group consisting of the first active node or the first tag overlay node being unloaded from the executable graph-based model, at least one of the group consisting of the first active node or the first tag overlay node in the executable graph-based model. The processing circuitry is further configured to load, based on the loading of the first active node, the first tag, in the executable graph-based model, in association with the first active node.

In some embodiments, based on the first active node being unloaded from the executable graph-based model, the processing circuitry is further configured to unload the first tag in association with the first active node.

In some embodiments, the first active node is one of a group consisting of an edge node, a vertex node, a role node, or an overlay node.

In some embodiments, based on the first active node being an edge node, the first active node is associated with a third active node and a fourth active node with the first active node coupling the third active node and the fourth active node.

In some embodiments, in response to an absence of a tag with the first tag type being associated with at least one of a group consisting of the third active node or the fourth active node, the processing circuitry is configured to associate the first tag to at least one of the group consisting of the third active node or the fourth active node with the first tag type. The first operation is executed further based on at least one of the group consisting of the third active node or the fourth active node, associated with the first tag.

In some embodiments, the first tag overlay node includes a processing logic that corresponds to a functionality of the first tag overlay node.

In some embodiments, the processing circuitry is further configured to receive a second stimulus associated with the overlay system. The processing circuitry is further configured to identify, based on the second stimulus, the first active node of the plurality of active nodes. The processing circuitry is further configured to determine a second tag overlay node-type of a second tag overlay node, of the plurality of tag overlay nodes, associated with the first active node. The processing circuitry is further configured to determine a fifth tag of the first set of tags. The fifth tag has a second tag type that matches the second tag overlay node-type of the second tag overlay node. The processing circuitry is further configured to execute, in response to the second stimulus, a second operation based on the first active node and the second tag overlay node. The execution of the second operation conforms with a second execution criterion indicated by the fifth tag.

In some embodiments, the processing circuitry is further configured to receive a third stimulus associated with the overlay system. The processing circuitry is further configured to identify, based on the third stimulus, a fifth active node of the plurality of active nodes. The processing circuitry is further configured to determine the first tag overlay node-type of the first tag overlay node associated with the fifth active node. The processing circuitry is further configured to determine a sixth tag of a second set of tags associated with the fifth active node. The sixth tag has the first tag type. The processing circuitry is further configured to execute, in response to the third stimulus, a third operation based on the fifth active node and the first tag overlay node. The execution of the third operation conforms with a third execution criterion indicated by the sixth tag.

In some embodiments, the executable graph-based model is a hierarchical structure. The first active node is a parent node of a sixth active node of the plurality of active nodes. The processing circuitry is further configured to determine an absence of a tag with the first tag type being associated with the sixth active node. The processing circuitry is further configured to associate, based on the absence of the tag with the first tag type being associated with the sixth active node, the first tag with the sixth active node. The first operation is executed further based on the sixth active node.

In some embodiments, the executable graph-based model further includes a plurality of generic overlay nodes. The first tag overlay node is further configured to inherit from one or more generic overlay nodes of the plurality of generic overlay nodes.

In some embodiments, the first tag overlay node is further configured to inherit from one or more tag overlay nodes of the plurality of tag overlay nodes.

In some embodiments, the first active node further includes a first overlay manager configured to manage the association of the first active node with the first tag overlay node.

In some embodiments, the executable graph-based model further includes a plurality of generic overlay nodes. The first tag overlay node is associated with at least one of a group consisting of (i) a first generic overlay node of the plurality of generic overlay nodes or (ii) a third tag overlay node of the plurality of tag overlay nodes with at least one of the group consisting of (i) the first generic overlay node or (ii) the third tag overlay node extending a functionality of the first tag overlay node. The first operation is executed further based on at least one of the group consisting of (i) the first generic overlay node or (ii) the third tag overlay node.

In some embodiments, the first tag overlay node further includes a second overlay manager configured to manage the association of the first tag overlay node with at least one of the group consisting of (i) the first generic overlay node or (ii) the third tag overlay node.

In some embodiments, the first active node is a generic node, and the first tag is a generic tag.

In some embodiments, the first active node is a run-time node including (i) a node template that corresponds to a predefined node structure, and (ii) a node instance that corresponds to an implementation of the node template. The first tag corresponds to a run-time tag including (i) a tag template that corresponds to a predefined tag structure, and (ii) a tag instance that corresponds to an implementation of the tag template.

In some embodiments, the processing circuitry is further configured to load the first active node based on a loading of the node template and the node instance. Based on the loading of the first active node, the processing circuitry is further configured to load the first tag based on a loading of the tag template and the tag instance of the first tag.

A method is provided. The method comprising receiving, by processing circuitry, a stimulus associated with an overlay system. The method further comprising an executable graph-based model is stored in a storage element of the overlay system. The executable graph-based model includes a plurality of active nodes associated with a plurality of tag overlay nodes. Each active node, of the plurality of active nodes, has a set of tags associated therewith, with each tag of the set of tags indicating an execution criterion for a tag overlay node of the plurality of tag overlay nodes. The method further comprising identifying, by the processing circuitry, based on the stimulus, a first active node of the plurality of active nodes. The method further comprising determining a first tag overlay node-type of a first tag overlay node, of the plurality of tag overlay nodes, associated with the first active node. The method further comprising determining, by the processing circuitry, a first tag of a first set of tags associated with the first active node. The first tag has a first tag type that matches the first tag overlay node-type of the first tag overlay node. The method further comprising executing, by the processing circuitry, in response to the stimulus, a first operation based on the first active node and the first tag overlay node. The execution of the first operation conforms with a first execution criterion indicated by the first tag.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

Embodiments of the present disclosure are illustrated by way of example and are not limited by the accompanying figures. Similar references in the figures may indicate similar elements. Elements in the figures are illustrated for simplicity and clarity and have not necessarily been drawn to scale.

FIG. 1 is a graph that illustrates a composition of an executable graph-based model, consistent with disclosed embodiments of the present disclosure;

FIG. 2 is a block diagram that illustrates a system environment of an overlay system for execution, management, and configuration of the executable graph-based model, consistent with disclosed embodiments of the present disclosure;

FIG. 3A is a block diagram that illustrates a standard structure of a generic node within the executable graph-based model, consistent with disclosed embodiments of the present disclosure;

FIG. 3B is a block diagram that illustrates a standard structure of a run-time node within the executable graph-based model, consistent with disclosed embodiments of the present disclosure;

FIG. 4A is a block diagram that illustrates an executable generic node within the executable graph-based model, consistent with disclosed embodiments of the present disclosure;

FIG. 4B is a block diagram that illustrates an executable run-time node within the executable graph-based model, consistent with disclosed embodiments of the present disclosure;

FIG. 5 is a block diagram that illustrates a composition of the executable generic node that enables persistent storage of data and processing logic associated therewith, consistent with disclosed embodiments of the present disclosure;

FIG. 6 is a graph that depicts an implementation of tags and tag overlay nodes in association with generic nodes of the executable graph-based model, consistent with disclosed embodiments of the present disclosure;

FIG. 7 is a graph that depicts an implementation of tags and tag overlay nodes in association with run-time nodes of the executable graph-based model, consistent with disclosed embodiments of the present disclosure;

FIG. 8 is a graph that depicts an implementation of tags and tag overlay nodes in association with active nodes in the executable graph-based model, consistent with disclosed embodiments of the present disclosure;

FIG. 9 shows an example computing system for carrying out methods of the present disclosure, consistent with disclosed embodiments of the present disclosure; and

FIG. 10 is a flowchart of a method for implementing tags and tag overlay nodes in association with active nodes in the executable graph-based model, consistent with disclosed embodiments of the present disclosure.

### DETAILED DESCRIPTION

The detailed description of the appended drawings is intended as a description of the embodiments of the present disclosure and is not intended to represent the only form in which the present disclosure may be practiced. It is to be understood that the same or equivalent functions may be accomplished by different embodiments that are intended to be encompassed within the spirit and scope of the present disclosure.

### Overview

Graph-based models have become increasingly prominent in various domains, such as computer networks, social networks, transportation systems, research and development, hospitality industry, healthcare industry, and biological systems, due to their capability to represent and analyze intricate relationships. Graph-based models include nodes such as vertex nodes, edge nodes, or the like. In these models, the vertex nodes symbolize entities, while the edge nodes represent connections or interactions between these entities. This structure enables graph-based models to effectively capture and process complex systems, making them essential for applications such as route optimization, network analysis, clustering, or the like. Their flexibility allows them to cater to a wide range of use cases, from analyzing social relationships to understanding biological processes.

To extend the capabilities of graph-based systems, overlay nodes are often introduced as enhancements to nodes (for example, vertex nodes, edge nodes, or the like). These overlay nodes are equipped with specialized processing logic that performs particular tasks or computations related to their associated nodes. This strategy enhances the functionality of graph-based models without altering their core architecture. However, challenges arise when the processing logic needs to focus on specific portions of a logical structure of the associated node while excluding others. This selective processing requirement complicates overlay node design, as the logic must include mechanisms to pinpoint, isolate, and operate on targeted parts of the logical structure of the node.

Executing processing logic on specific parts of a logical structure of an associated node presents several technical challenges. Firstly, the logic must reliably identify and isolate the relevant section of the logical structure of the node, often necessitating the use of sophisticated algorithms or heuristics. This task becomes even more challenging in dynamic or large-scale systems, where the node’s structure or state can frequently change. Additionally, ensuring that the processing logic interacts exclusively with the intended portion of the logical structure of the node without impacting other areas requires thorough testing and validation. The aforementioned requirements associated with the execution of the processing logic induce various implications by impacting problem identification, root-cause analysis, and resource utilization. Hence, the execution of the processing logic becomes significantly complex.

Moreover, the requirement for selective execution often leads to overly specific and redundant code pathways within overlay nodes. This not only escalates computational overhead but also reduces the reusability and adaptability of overlay nodes for other applications. In environments with strict performance requirements, such as real-time analytics or low-latency systems, the added computational load from selective processing can become a major bottleneck. Additionally, the debugging and maintenance of such complex logic demand specialized skills, further increasing operational costs and complicating system upkeep. The intricate nature of overlay node design presents challenges such as computational overhead, longer development timelines, and maintenance requirements, which can be particularly impactful in resource-constrained settings where efficiency, simplicity, and scalability are priorities.

The present disclosure is directed to application of tags and tag overlay nodes by way of an executable graph-based model of an overlay system. The executable graph-based model is a customized hypergraph with hyper-edges that are realized by way of active nodes. Each active node is associated with a particular node-type. An active node may be a vertex node, an edge node, a role node, or an overlay node. For example, an edge node corresponds to a base node with an edge node-type. Nodes (for example, base nodes and executable nodes) are connected with other nodes by way of roles included in an edge node therebetween. In some embodiments, roles are represented by way of nodes of role node-type. A role node between two nodes may be indicative of a context regarding an association therebetween. The executable graph-based model also includes a plurality of overlay nodes that incorporate in-situ features (for example, modification of signals) in the overlay system. Each overlay node is associated with one or more nodes (for example, a vertex node, an edge node, or the like) of the executable graph-based model and includes a corresponding processing logic that when executed implements a functionality thereof on the associated nodes.

The overlay system disclosed herein facilitates the executable graph-based model that includes a plurality of active nodes (for example, vertex nodes, edge nodes, or the like) and a plurality of tag overlay nodes. Each active node is associated with a set of tags and one or more tag overlay nodes of the plurality of tag overlay nodes. Each tag of the set of tags may be associated with a tag type, an execution criterion, and a tag configuration. The tag may be indicative of an execution approach to be applied while executing a tag overlay node that has a tag overlay node-type that matches the tag type of the tag. For example, the tag may be an obfuscation tag and the tag overlay node may be an obfuscation overlay node. In such an example, the tag type may be an obfuscation tag type and the tag overlay node-type may be an obfuscation overlay node-type. The obfuscation tag type may match the obfuscation overlay node-type. Therefore, the tag type of the tag may match the tag overlay node-type of the tag overlay node. Moreover, the execution criterion may be indicative of an operational behavior of the tag overlay node in association with the active node. With respect to the above-discussed example, the execution criterion may be ‘include’. Therefore, the active node may be included in the execution of processing logic of the tag overlay node. Further, the tag configuration of the tag may be indicative of a technique to be applied while executing the processing logic of the tag overlay node on the active node. With respect to the ongoing example, the configuration may be indicative of a character length, obfuscation characters to be used, and a fore end or a hind end of data stored at the active node that may be obfuscated using the tag overlay node. Hence, the tag overlay node may be executed on the active node in conformity (namely, based on) with the execution criterion indicated by the tag while also applying the tag configuration indicated by the tag.

In some embodiments, the execution criterion of the tag may be indicative of the active node being excluded from the execution of processing logic of the tag overlay node. In such embodiments, the tag overlay node may not be executed on the active node.

In some embodiments, the execution criterion of the tag may be indicative of the active node being included in the execution of processing logic of the tag overlay node. In such embodiments, the tag overlay node may be executed on the active node.

The active node may include a plurality of node elements that may store data and/or processing logic associated with the active node. Each tag of the set of tags may be associated with the active node and/or the plurality of node elements thereof by way of a node level association or a node element level association. In some embodiments, when the tag may be associated with a node element, the node element may be included in the execution of the tag overlay node or excluded from the execution of the tag overlay node as described above with respect to the active node. In a scenario, when a node element may not be associated with a tag having a tag type that matches the tag overlay node-type of the tag overlay node, the tag associated with the active node at node level may be associated with the said tag.

Notably, the present disclosure facilitates tags and tag overlay nodes implemented by way of the overlay system. The disclosed embodiments provide a range of advantages, including a simplified and user-friendly implementation of an executable graph-based model that facilitates implementation of the tags and the tag overlay nodes. The described systems and methods enable significant simplification of processing logic of overlay nodes (for example, tag overlay nodes) while maintaining its functionality. Further, such simplification of processing logic may also be reflected in execution thereof. Such advancements do not only reduce costs and development time but also improve the efficiency and scalability of graph-based models, enabling them to achieve their full potential across diverse applications. In addition, the implementation of the tags and tag overlay nodes in the overlay system allows the active nodes to be updated to include new data or processing logic without having to worry about an appropriate execution of the processing logic of the tag overlay node associated with the active node. Also, changes in the active node may be made without making a change in an associated overlay node. For example, addition of a new attribute to the active node may only require association of a relevant tag with the new attribute for executing the associated tag overlay node correctly on the new attribute. Hence, such advantages associated with the tags and the tag overlay nodes lead to significantly enhanced throughput and efficiency, along with notable reductions in cost, processing complexity, time complexity, latency, waiting periods, turnaround time, and other related metrics of the overlay system.

### Figure Description

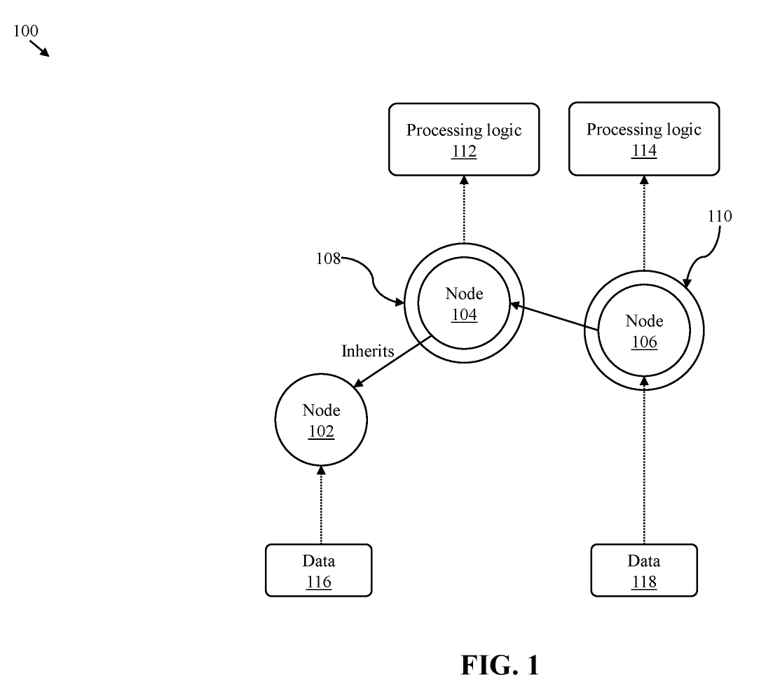

FIG. 1 is a graph that illustrates a composition of an executable graph-based model 100, consistent with disclosed embodiments of the present disclosure. Referring to FIG. 1, the executable graph-based model 100 is generally formed of a data structure (e.g., a graph-based model or a graphical model) comprising a plurality of nodes 102-106. Each of the plurality of nodes 102-106 may be an active node. Each of the plurality of nodes 102-106 may be functionally extended with processing logic via the use of overlays. For example, as shown in FIG. 1, the nodes 104 and 106 are functionally extended with processing logic via the use of overlay nodes 108 and 110, respectively. Although not shown, the node 102 can be similarly extended with processing logic via the use of one or more overlays. Each overlay includes processing logic, such as processing logic 112 and 114 which are associated with the overlay nodes 108 and 110, respectively. At run-time, data, such as data 116 and 118, is associated with the nodes 102 and 106, respectively. Further, the overlay nodes 108 and 110 of the nodes 104 and 106, respectively, provide the functionality to respond to stimuli and interact with, manipulate, or otherwise process the data based on the stimuli. Further, the node 104 inherits the node 102, and hence, also inherits the data 116 which is associated with the node 102. In some embodiments, the node 102 may be extended to have one or more overlays. In such embodiments, the node 104 may further inherit the overlays of the node 102.

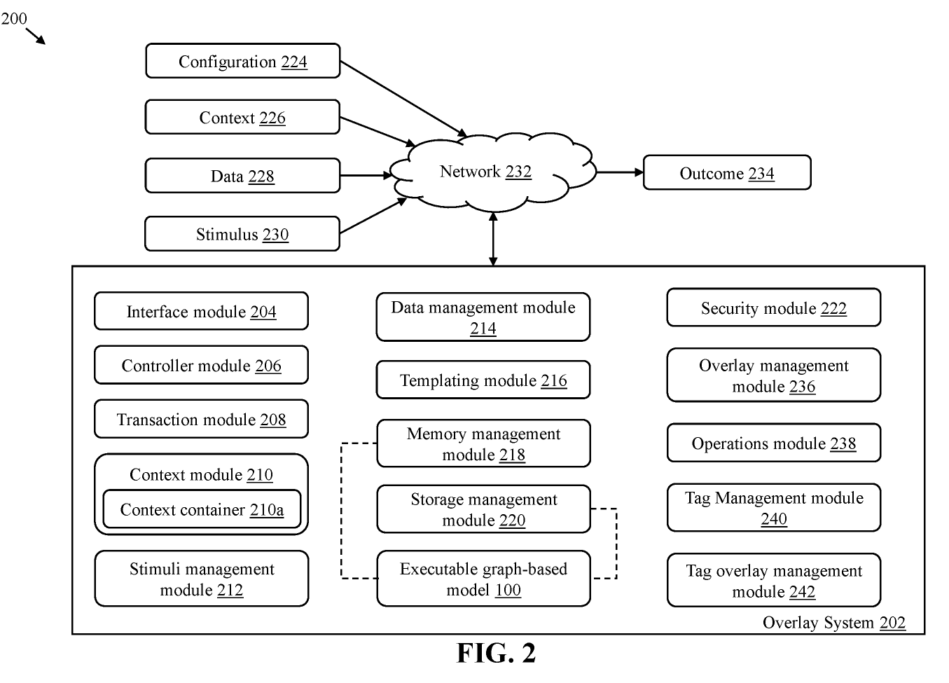

Each element within the executable graph-based model 100 (both the data and the processing functionality) is implemented by way of a node. A node forms the fundamental building block of all executable graph-based models. A node may be an executable node. A node that is extended by way of an overlay node forms an executable node. One or more nodes are extended to include overlays in order to form the executable graph-based model 100. As such, the executable graph-based model 100 includes one or more nodes that can be dynamically generated, extended, or processed by one or more other modules within an overlay system (shown in FIG. 2). Throughout the description, the terms “overlay node” and “overlay” are used interchangeably.

Notably, the structure and functionality of the data processing are separate from the data itself when offline (or at rest) and are combined dynamically at run-time. The executable graph-based model 100 thus maintains the separability of the data and the processing logic when offline. Moreover, by integrating the data and the processing logic within a single model, processing delays or latencies are reduced because the data and the processing logic exist within the same logical system. Therefore, the executable graph-based model 100 applies to a range of time-critical systems where efficient processing of the stimuli is required.

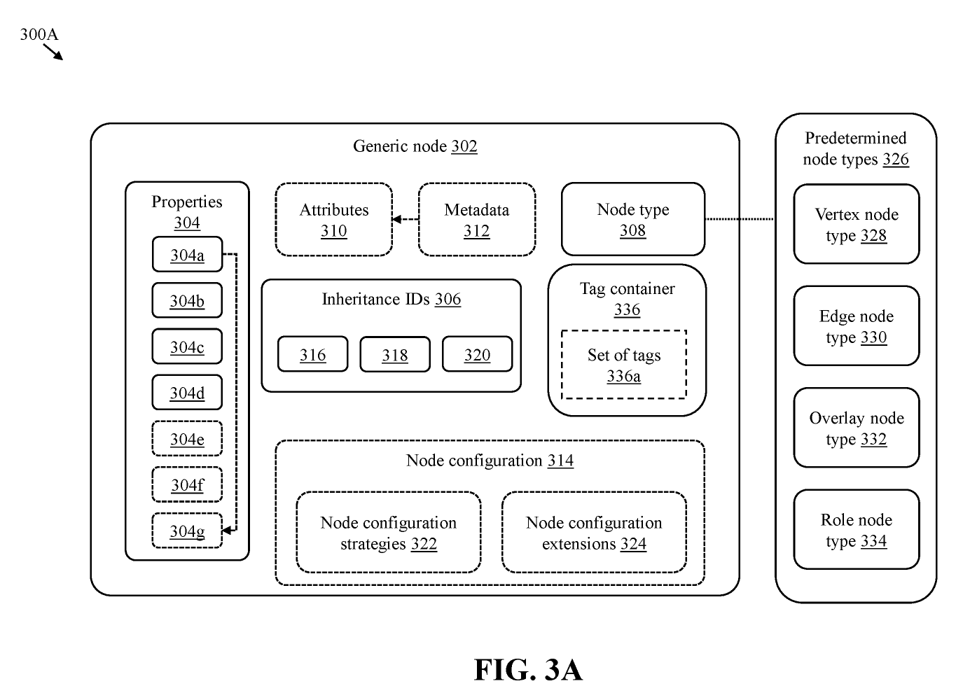

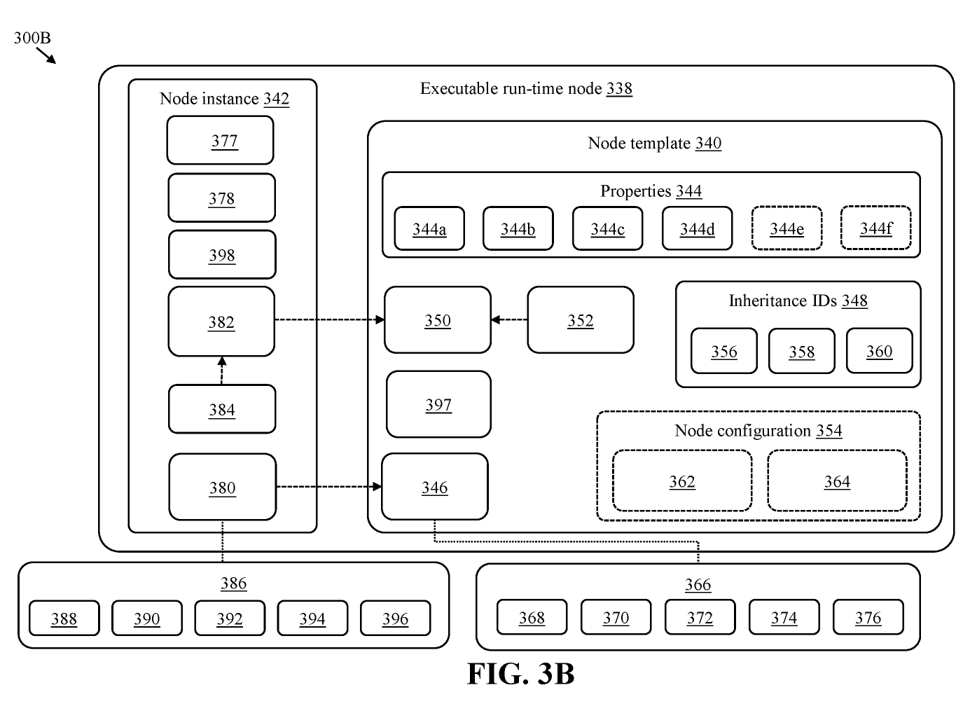

FIG. 2 is a block diagram that illustrates a system environment 200 of an overlay system 202 for execution, management, and configuration of the executable graph-based model 100, consistent with disclosed embodiments of the present disclosure. Referring to FIG. 2, the overlay system 202 includes the executable graph-based model 100. The overlay system 202 further includes an interface module 204, a controller module 206, a transaction module 208, a context module 210, a stimuli management module 212, a data management module 214, a templating module 216, a memory management module 218, a storage management module 220, and a security module 222. FIG. 2 further shows a configuration 224, a context 226, data 228, a stimulus 230, a network 232, and an outcome 234. Additionally, the overlay system 202 of the present disclosure includes an overlay management module 236, an operations module 238, a tag management module 240, and a tag overlay management module 242. In some embodiments, all the modules of the overlay system 202 except for the executable graph-based model 100 may collectively form processing circuitry that facilitates operations associated with implementation of tags and tag overlay nodes, in the executable graph-based model 100. A tag, when associated with a node or a node element may be indicative of an execution approach of a tag overlay node that may be directly or indirectly associated with the node. A tag overlay node may be an overlay node of the executable graph-based model 100 that may be executed in accordance with a tag of an associated node that may have a tag type that matches a tag overlay node-type thereof. Throughout the description, nodes included in the executable graph-based model 100 are referred to as active nodes. An active node may be a generic node (described in conjunction with FIG. 3A) or a run-time node (described in conjunction with FIG. 3B).

The overlay system 202 may include suitable logic, circuitry, interfaces, and/or code, executable by the circuitry, that may be configured to facilitate one or more operations associated with the active nodes in the executable graph-based model 100.

The interface module 204 may include suitable logic, circuitry, interfaces, and/or code, executable by the circuitry, configured to provide a common interface between internal modules of the overlay system 202 and/or external sources. The interface module 204 provides an application programmable interface (API), scripting interface, or any other suitable mechanism for interfacing externally or internally with any module of the overlay system 202. The configuration 224, the context 226, the data 228, and the stimulus 230 may be received by the interface module 204 via the network 232. Similarly, outputs (e.g., the outcome 234) produced by the overlay system 202 are passed by the interface module 204 to the network 232 for consumption or processing by external systems. In one embodiment, the interface module 204 supports one or more messaging patterns or protocols such as the simple object access protocol (SOAP), the representational state transfer (REST) protocol, or the like. The interface module 204 thus allows the overlay system 202 to be deployed in any number of application areas, operational environments, or architecture deployments. Although not illustrated in FIG. 2, the interface module 204 is communicatively coupled (e.g., connected either directly or indirectly) to one or more other modules or elements within the overlay system 202 (such as the controller module 206, the context module 210, the executable graph-based model 100, or the like). In one embodiment, the interface module 204 is communicatively coupled (e.g., connected either directly or indirectly) to one or more overlays within the executable graph-based model 100.

The controller module 206 may include suitable logic, circuitry, interfaces, and/or code, executable by the circuitry, configured to handle and process interactions and executions within the overlay system 202. As will be described in more detail below, stimuli (such as the stimulus 230) and their associated contexts (such as the context 226) provide the basis for all interactions within the executable graph-based model 100. Processing of such stimuli may lead to execution of processing logic associated with one or more overlays within the executable graph-based model 100. The processing of the stimuli within the overlay system 202 may be referred to as a system transaction. The processing and execution of stimuli (and associated overlay execution) within the overlay system 202 is handled by the controller module 206. The controller module 206 manages all received input stimuli (e.g., the stimulus 230) and processes them based on a corresponding context (e.g., the context 226). The context 226 determines the priority that is to be assigned to the processing of the corresponding stimulus by the controller module 206 or the context module 210. This allows each stimulus to be configured with a level of importance and prioritization within the overlay system 202. The controller module 206 may maintain the integrity of the modules within the overlay system 202 before, during, and after a system transaction.

The transaction module 208, which is associated with the controller module 206, is responsible for maintaining the integrity of the overlay system 202 through the lifecycle of a transaction. Maintaining system integrity via the controller module 206 and the transaction module 208 allows a transaction to be rolled back in an event of an expected or unexpected software or hardware fault or failure. The controller module 206 is configured to handle the processing of the stimulus 230 and transactions through architectures such as parallel processing, grid computing, priority queue techniques, or the like. In one embodiment, the controller module 206 and the transaction module 208 are communicatively coupled (e.g., connected either directly or indirectly) to one or more overlays within the executable graph-based model 100.

As stated briefly above, the overlay system 202 utilizes a context-driven architecture, whereby the stimulus 230 within the overlay system 202 is associated with the context 226 which is used to adapt the handling or processing of the stimulus 230 by the overlay system 202. That is to say that the handling or processing of the stimulus 230 is done based on the context 226 associated therewith. Hence, the stimulus 230 is a contextualized stimulus. The context 226 may include details such as username, password, access token, device information, time stamp, one or more relevant identifiers (IDs), or the like, that are required for processing of the stimulus 230 within the executable graph-based model 100. Each context within the overlay system 202 may be extended to include additional information that is required for the processing of the stimulus (e.g., a query, a command, an instruction, or an event).

The context module 210 may include suitable logic, circuitry, interfaces, and/or code, executable by the circuitry, configured to manage the handling of contexts within the overlay system 202. The context module 210 is responsible for processing any received contexts (e.g., the context 226) and translating the received context to an operation execution context. In some examples, the operation execution context is larger than the received context because the context module 210 supplements the received context with further information necessary for the processing of the received context. The context module 210 passes the operation execution context to one or more other modules within the overlay system 202 to drive communication of data associated with the operation execution context. Contexts within the overlay system 202 can be external or internal. While some contexts apply to all application areas and problem spaces, some applications may require specific contexts to be generated and used to process the received stimulus 230. As will be described in more detail below, the executable graph-based model 100 is configurable (e.g., via the configuration 224) so as only to execute within a given execution context for a given stimulus.

As shown, the context module 210 includes a context container 210a that includes a set of defined contexts. Each defined context of the set of defined contexts pertains to a context that is associated with one or more operations for facilitating application and management of the plurality of active nodes (for example, generic nodes and/or run-time nodes) in the overlay system 202. That is to say that one or more contexts of the set of defined contexts are indicative of the one or more operations to be executed by way of one or more active nodes in the overlay system 202. The one or more operations are executed when a context of a corresponding stimuli matches one of the set of defined contexts.

The stimuli management module 212 may include suitable logic, circuitry, interfaces, and/or code, executable by the circuitry, configured to process externally received stimuli (e.g., the stimulus 230) and any stimuli generated internally from any module within the overlay system 202. The stimuli management module 212 is communicatively coupled (e.g., connected either directly or indirectly) to one or more overlays within the executable graph-based model 100 to facilitate the processing of stimuli within the executable graph-based model 100. The overlay system 202 utilizes different types of stimuli such as a command (e.g., a transactional request), a query, or an event received from an external system such as an Internet-of-Things (IoT) device. As previously stated, a stimulus (such as the stimulus 230) can be either externally or internally generated. In an example, the stimulus 230 may be a message that is internally triggered (e.g., generated) from any of the modules within the overlay system 202. Such internal generation of the stimulus 230 indicates that something has happened within the overlay system 202 and subsequent handling by one or more other modules within the overlay system 202 may be required. Internal stimulus 230 can also be triggered (e.g., generated) from the execution of processing logic associated with overlays within the executable graph-based model 100. In another example, the stimulus 230 may be externally triggered and may be generated based on an input received via a user interface associated with the controller module 206. The externally triggered stimulus 230 may be received in the form of a signal, a textual, audio, or visual input. The externally triggered stimulus 230 may be associated with the intent of a user to execute an operation indicated by the stimulus 230. The operation is executed in accordance with information included in the context 226 associated with the stimulus 230.

The stimuli management module 212 may receive the stimuli (such as the stimulus 230) in real-time or near-real-time and communicate the received stimuli to one or more other modules or nodes of the executable graph-based model 100. In some examples, the stimuli are scheduled in a batch process. The stimuli management module 212 utilizes any suitable synchronous or asynchronous communication architectures or approaches in communicating the stimuli (along with associated information). The stimuli within the overlay system 202 are received and processed (along with a corresponding context) by the stimuli management module 212, which then determines the processing steps to be performed for the communication of data associated with each stimulus. In one embodiment, the stimuli management module 212 processes the received stimuli in accordance with a predetermined configuration (e.g., the configuration 224) or dynamically determines what processing needs to be performed based on the contexts associated with the stimuli and/or based on a state of the executable graph-based model 100. The state of the executable graph-based model 100 refers to the current state of each node of the executable graph-based model 100 at a given point in time. The state of the executable graph-based model 100 is dynamic, and hence, may change based on processing of data by any of its nodes. In some examples, the processing of a stimulus (such as the stimulus 230) results in the generation, communication, or processing of data that further results in one or more outcomes (e.g., the outcome 234) being generated. Such outcomes are either handled internally by one or more modules in the overlay system 202 or communicated via the interface module 204 as an external outcome. In one embodiment, all stimuli and corresponding outcomes are recorded for auditing and post-processing purposes by, for example, the operations module 238 of the overlay system 202.

The data management module 214 may include suitable logic, circuitry, interfaces, and/or code, executable by the circuitry, configured to manage all data or information within the overlay system 202 (e.g., the data 228) for a given application. Operations performed by the data management module 214 include data loading, data unloading, data modeling, and data processing. The data management module 214 is communicatively coupled (e.g., connected either directly or indirectly) to one or more other modules within the overlay system 202 to complete some or all of these operations. For example, data storage is handled by the data management module 214 in conjunction with the memory management module 218 and the storage management module 220.

The templating module 216 may include suitable logic, circuitry, interfaces, and/or code, executable by the circuitry, configured to enable the overlay system 202 to implement a templated version of one or more active nodes of the executable graph-based model 100. The templating module 216 may be configured to create one or more predefined templates in the executable graph-based model 100. The templating module 216 may be further configured to generate one or more node instances of the predefined templates for the implementation of the templated version of the executable graph-based model 100. The templating module 216 may be communicatively coupled (i.e., connected either directly or indirectly) to one or more nodes and/or one or more overlays within the executable graph-based model 100. The templating module 216 may be further configured to implement run-time tags based on tag templates and tag instance associated therewith. A tag template may define a pre-defined tag structure whereas a tag instance may be an implementation of the tag template. The tag template and the tag instance may, collectively, constitute the run-time tag.

The memory management module 218 may include suitable logic, circuitry, interfaces, and/or code, executable by the circuitry, configured to manage and optimize the memory usage of the overlay system 202. The memory management module 218 thus helps to improve the responsiveness and efficiency of the processing performed by one or more of the modules within the overlay system 202 by optimizing the memory handling performed by these modules. The memory management module 218 uses direct memory or some form of distributed memory management architecture (e.g., a local or remote caching solution). Additionally, or alternatively, the memory management module 218 deploys multiple different types of memory management architectures and solutions (e.g., reactive caching approaches such as lazy loading or a proactive approach such as write-through cache may be employed). These architectures and solutions are deployed in the form of a flat (single-tiered) or multi-tiered caching architecture where each layer of the caching architecture can be implemented using a different caching technology or architecture solution approach. In such implementations, each cache or caching tier can be configured (e.g., by the configuration 224) independent of the requirements for one or more modules of the overlay system 202. For example, data priority and an eviction strategy, such as least-frequently-used (LFU) or least-recently-used (LRU), can be configured for all or parts of the executable graph-based model 100. In one embodiment, the memory management module 218 is communicatively coupled (e.g., connected either directly or indirectly) to one or more overlays within the executable graph-based model 100.

The storage management module 220 may include suitable logic, circuitry, interfaces, and/or code, executable by the circuitry, configured to manage the temporary or permanent storage of data associated with the overlay system 202. The storage management module 220 is any suitable low-level storage device solution (such as a file system) or any suitable high-level storage technology such as another database technology (e.g., relational database management system (RDBMS) or NoSQL database). The storage management module 220 is directly connected to the storage device upon which the relevant data is persistently stored. For example, the storage management module 220 can directly address the computer-readable medium (e.g., hard disk drive, external disk drive, or the like) upon which the data is being read or written. Alternatively, the storage management module 220 is connected to the storage device via a network such as the network 232. As will be described in more detail later in the present disclosure, the storage management module 220 uses manifests to manage the interactions between the storage device and the modules within the overlay system 202. In one embodiment, the storage management module 220 is communicatively coupled (e.g., connected either directly or indirectly) to one or more overlays within the executable graph-based model 100. Throughout the description, the term ‘storage device’ is used interchangeably with the term ‘storage element’.

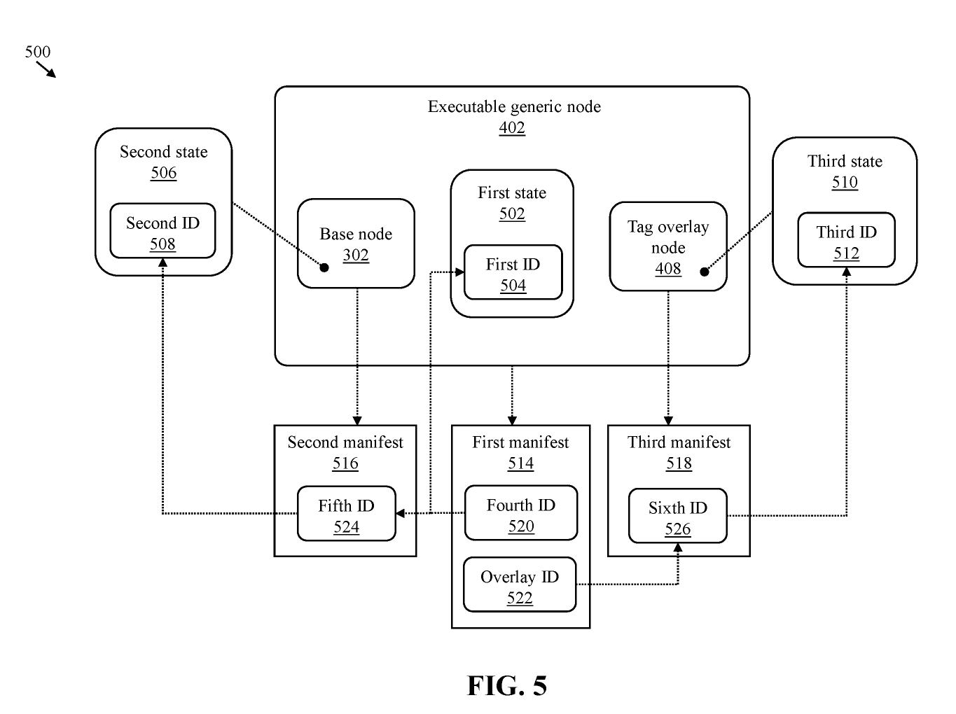

As described, storage, loading, and unloading of the executable graph-based model 100 or one or more components thereof is facilitated by the memory management module 218 and the storage management module 220. The memory management module 218 and the storage management module 220 may facilitate such operations by interacting with the storage device that stores the executable graph-based model 100. The overlay system 202 further includes a plurality of manifest storages. The manifest storages are used by the memory management module 218 and the storage management module 220 to facilitate storage manifest states (including manifest template states and manifest instance states) of nodes. The storage element may include a primary storage and a secondary storage. The primary storage may store the executable graph-based model 100 and may also store nodes that are loaded in the executable graph-based model 100. The secondary storage may store node states, manifests, and manifest states associated with nodes that are unloaded from the executable graph-based model 100. Storage and retrieval of nodes are described in detail in conjunction with FIG. 5. Throughout the description the terms ‘node’ and ‘active node’ are used interchangeably.

The security module 222 may include suitable logic, circuitry, interfaces, and/or code, executable by the circuitry, configured to manage the security of the overlay system 202. This includes security at a system level and a module level. Security is hardware-related, network-related, or software-related, depending on the operational environment, the architecture of the deployment, or the data and information contained within the overlay system 202. For example, if the system is deployed with a web-accessible API (as described above in relation to the interface module 204), the security module 222 can enforce a hypertext transfer protocol secure (HTTPS) protocol with the necessary certification. As a further example, if the data or information associated with the data associated with the overlay system 202 contains Personally Identifiable Information (PII) or Protected Health Information (PHI), the security module 222 can implement one or more layers of data protection to ensure that the PII or PHI are correctly processed and stored. In an additional example, in implementations whereby the overlay system 202 operates on United States of America citizen medical data, the security module 222 may enforce additional protections or policies as defined by the United States Health Insurance Portability and Accountability Act (HIPAA). Similarly, if the overlay system 202 is deployed in the European Union (EU), the security module 222 may enforce additional protections or policies to ensure that the data processed and maintained by the overlay system 202 complies with the General Data Protection Regulation (GDPR). In one embodiment, the security module 222 is communicatively coupled (e.g., connected either directly or indirectly) to one or more overlays within the executable graph-based model 100, thereby directly connecting security execution to the data/information in the executable graph-based model 100. The security module 222 thus acts as a centralized coordinator that works in conjunction with the overlay management module 236 for managing and executing security-based overlays.

The overlay management module 236 may include suitable logic, circuitry, interfaces, and/or code, executable by the circuitry, configured to manage all overlays within the overlay system 202. Operations performed by the overlay management module 236 include overlay storage management, overlay structure modeling, overlay logic creation and execution, and overlay loading and unloading (within the executable graph-based model 100). The overlay management module 236 is communicatively coupled (e.g., connected either directly or indirectly) to one or more other modules within the overlay system 202 to complete some or all of these operations. For example, overlays can be persisted in some form of physical storage using the storage management module 220 (as described in more detail below). As a further example, overlays can be compiled and preloaded into memory via the memory management module 218 for faster run-time execution.

The operations module 238 may include suitable logic, circuitry, interfaces, and/or code, executable by the circuitry, configured to track operational metrics and the behavior of all modules of the overlay system 202. Operational metrics of a module are indicative of statistics associated with the performance of the module while performing an operation (for example, communication, data processing, stimulus processing, or the like).

The tag management module 240 may include suitable logic, circuitry, interfaces, and/or code, executable by the circuitry, configured to perform various operations such as create, maintain, manage, associate, update, remove, or the like associated with a set of tags associated with each active node of the executable graph-based model 100. The tag management module 240 may be further configured to associate relevant tags to each active node. The tag management module 240 may be further configured to, for each tag, define a tag type, an execution criterion, a tag configuration, and an operational technique (namely, a set of operational techniques) associated with the tag configuration.

The tag overlay management module 242 may include suitable logic, circuitry, interfaces, and/or code, executable by the circuitry, configured to manage all tag overlay nodes within the overlay system 202. Operations performed by the tag overlay management module 242 include overlay storage management, overlay structure modeling, overlay logic creation and execution, and overlay loading and unloading (within the executable graph-based model 100) of a plurality of tag overlay nodes of the executable graph-based model 100. The tag overlay management module 242 is communicatively coupled (e.g., connected either directly or indirectly) to one or more other modules within the overlay system 202 to complete some or all of these operations. For example, tag overlays can be persisted in some form of physical storage using the storage management module 220 (as described in more detail below). As a further example, tag overlays can be compiled and preloaded into memory via the memory management module 218 for faster run-time execution. Notably, a tag overlay node is a generic overlay node that executes in conformity with an execution criterion indicated by a tag of an active node associated therewith. Therefore, one or more operations associated with the creation and management of the tag overlay nodes may be executed by the overlay management module 236. For the sake of brevity, the tag overlay management module 242 is shown as a separate component of the overlay system 202. In some embodiments, the tag overlay management module 242 may be integral to the overlay management module 236. The overlay nodes in the executable graph-based model 100 that may not be tag overlay nodes are referred to as generic overlay nodes.

The functionality of two or more of the modules included in the overlay system 202 may be combined within a single module. Conversely, the functionality of a single module can be split into two or more further modules which can be executed on two or more devices. The modules described above in relation to the overlay system 202 can operate in a parallel, distributed, or networked fashion. Such a module as a unit or in combination with one or more other modules of the overlay system 202 may form processing circuitry of the overlay system 202.

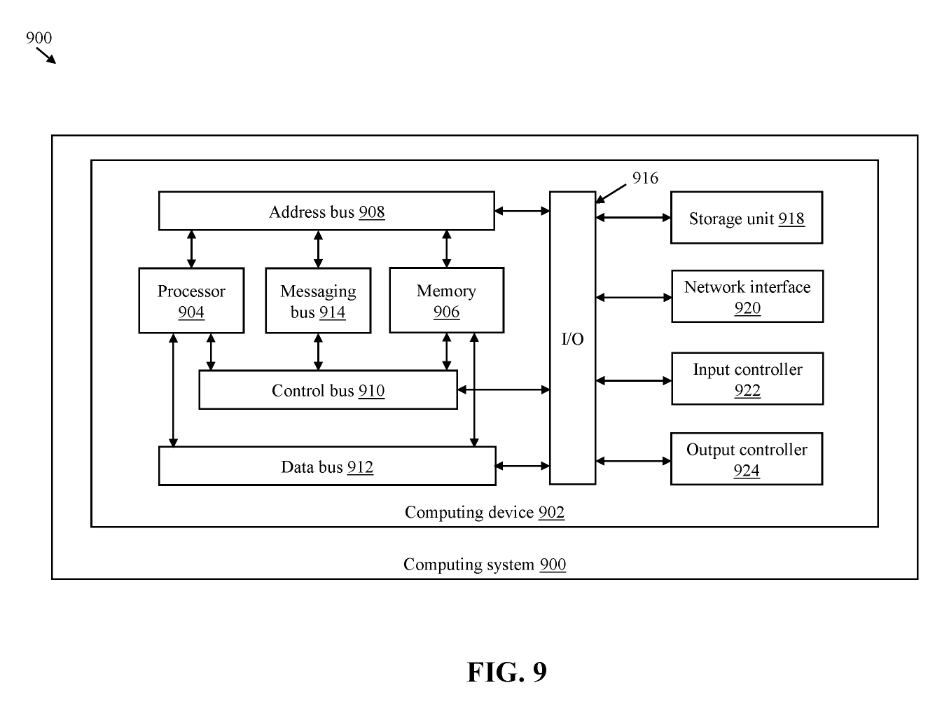

Beneficially, various features of the overlay system support the processing circuitry and a computing system (shown in FIG. 9) implementing the overlay system 202 in significantly enhancing its performance. The significant enhancement in performance may include significantly increased throughput and efficiency and significantly reduced cost complexity, processing complexity, time complexity, latency, waiting time, turnaround time, or the like.

The overlay system 202 may be implemented in software, hardware, or a combination of both software and hardware. Examples of suitable hardware modules include, but are not limited to, a general-purpose processor, a field programmable gate array (FPGA), and/or an application-specific integrated circuit (ASIC). Software modules can be expressed in a variety of software languages such as C, C++, Java, Ruby, Visual Basic, Python, and/or other object-oriented, procedural, or functional programming languages.

Although it is described that the overlay system 202 includes a single executable graph-based model (e.g., the executable graph-based model 100), the scope of the present disclosure is not limited to it. In other embodiments, the overlay system 202 may include more than one executable graph-based model, without deviating from the scope of the present disclosure. In such a scenario, each executable graph-based model is implemented and managed in a manner that is similar to the executable graph-based model 100.

Having described the overlay system 202 for executing and managing executable graph-based models, the description will now turn to the elements of an executable graph-based model; specifically, the concept of an active node. Unlike conventional graph-based systems, all elements (e.g., data, overlays, etc.) within the executable graph-based model (e.g., the executable graph-based model 100) are implemented as active nodes. As will become clear, this allows executable graph-based models to be flexible, extensible, and highly configurable.

Notably, an active node may be a generic node or a run-time node. The generic node may be a non-templated form of the active node whereas the run-time node may be a templated form of the active node.

FIG. 3A is a block diagram 300A that illustrates a standard structure of a generic node 302 within the executable graph-based model 100, consistent with disclosed embodiments of the present disclosure. Referring to FIG. 3A, the generic node 302 corresponds to the core structure of the executable graph-based model 100 and forms the foundational building block for all data and processing logic within the executable graph-based model 100. The generic node 302 includes properties 304, inheritance IDs 306, and a node-type 308. The generic node 302 optionally includes one or more attributes 310, metadata 312 associated with the attributes 310, and a node configuration 314.

The properties 304 of the generic node 302 include a unique ID 304a, a version ID 304b, a namespace 304c, and a name 304d. The properties 304 optionally include one or more icons 304e, one or more labels 304f, and one or more alternative IDs 304g. The inheritance IDs 306 of the generic node 302 include an abstract flag 316, a leaf flag 318, and a root flag 320. The node configuration 314 optionally includes one or more node configuration strategies 322 and one or more node configuration extensions 324.

The unique ID 304a is unique for each node within the executable graph-based model 100. The unique ID 304a is used to register, manage, and reference the generic node 302 within the system (e.g., the overlay system 202). In some embodiments, the one or more alternative IDs 304g are associated with the unique ID 304a to help manage communications and connections with external systems (e.g., during configuration, sending stimuli, or receiving outcomes). The version ID 304b of the generic node 302 is incremented when the generic node 302 undergoes transactional change. This allows the historical changes between versions of the generic node 302 to be tracked by modules or overlays within the overlay system 202. The namespace 304c of the generic node 302, along with the name 304d of the generic node 302, is used to help organize nodes within the executable graph-based model 100. That is, the generic node 302 is assigned a unique name 304d within the namespace 304c such that the name 304d of the generic node 302 need not be unique within the entire executable graph-based model 100, only within the context of the namespace 304c to which the generic node 302 is assigned. The generic node 302 optionally includes one or more icons 304e which are used to provide a visual representation of the generic node 302 when visualized via a user interface. The one or more icons 304e can include icons at different resolutions and display contexts such that the visualization of the generic node 302 is adapted to different display settings and contexts. The generic node 302 also optionally includes one or more labels 304f which are used to override the name 304d when the generic node 302 is rendered or visualized.

The generic node 302 supports the concept of inheritance of data and processing logic associated with any other node of the executable graph-based model 100 that is inherited by the generic node 302. This allows the behavior and functionality of the generic node 302 to be extended or derived from the inherited node of the executable graph-based model 100. The inheritance IDs 306 of the generic node 302 indicate the inheritance-based information, which may apply to the generic node 302. The inheritance IDs 306 comprise a set of Boolean flags that identify the inheritance structure of the generic node 302. The abstract flag 316 allows the generic node 302 to support the construct of abstraction. When the abstract flag 316 takes a value ‘true’, the generic node 302 is flagged as abstract that is to say that it cannot be instantiated or created within an executable graph-based model (e.g., the executable graph-based model 100). Thus, in an instance when the generic node 302 has the abstract flag 316 set to ‘true’, the generic node 302 may only form the foundation of other nodes that inherit therefrom. By default, the abstract flag 316 of the generic node 302 is set to ‘false’. The leaf flag 318 is used to indicate whether any other node may inherit from the generic node 302. If the leaf flag 318 is set to ‘true’, then no other node may inherit from the generic node 302 (but unlike an abstract node, a node with the leaf flag 318 set may be instantiated and created within the executable graph-based model 100). The root flag 320 is used to indicate whether the generic node 302 inherits from any other node. If the root flag 320 is set to ‘true’, the generic node 302 does not inherit from any other node. The generic node 302 is flagged as leaf (e.g., the leaf flag 318 is set to ‘true’) and/or root (e.g., the root flag 320 is set to ‘true’), or neither (e.g., both the leaf flag 318 and the root flag 320 are set to ‘false’). It will be apparent to a person skilled in the art that a node cannot be flagged as both abstract and leaf (e.g., the abstract flag 316 cannot be set to ‘true’ whilst the leaf flag 318 is set to ‘true’).

As stated above, all elements of the executable graph-based model 100 are defined as nodes. This functionality is in part realized due to the use of a node-type. The node-type 308 of the generic node 302 is used to extend the functionality of the generic node 302. All nodes within the executable graph-based model 100 comprise a node-type that defines additional data structures and implements additional executable functionality. A node-type thus includes data structures and functionality that are common across all nodes that share that node-type. Therefore, composition of a node with a node-type improves extensibility by allowing the generation of specialized node functionalities for specific application areas. Such extensibility is not present in prior art graph-based models. As illustrated in FIG. 3A, the generic node 302 and the node-type 308 are one logical unit that is not separated in the context of an executing system at run-time (e.g., in the context of execution of an executable graph-based model).

FIG. 3A further shows the plurality of predetermined node-types 326 which provides a non-exhaustive list of node-types for the node-type 308 associated with the generic node 302. The plurality of predetermined node-types 326 includes a vertex node-type 328 and an edge node-type 330. The vertex node-type 328 (also referred to as a data node-type or a value node-type) includes common data structures and functionality related to the ‘things’ modeled in the graph (e.g., the data). The edge node-type 330 includes common data structures and functionality related to coupling/linking/associating two or more nodes. A node having the edge node-type 330 may connect two or more nodes and thus the edge node-type 330 constructs associations and connections between nodes (for example, objects or ‘things’) within the executable graph-based model 100. The edge node-type 330 is not restricted to the number of nodes that can be associated or connected by a node having the edge node-type 330. The data structures and functionality of the edge node-type 330 thus define a hyper-edge which allows two or more nodes to be connected through a defined set of roles. A role defines a connective relationship between the two or more nodes, and hence, allows an edge node to connect two or more nodes such that the two or more nodes may have more than one relationship therebetween.

The plurality of predetermined node-types 326 further includes an overlay node-type 332, and a role node-type 334. The overlay node-type 332 may correspond to overlay node-type for a generic overlay node as well as a tag overlay node. As will be described in more detail below, a node with the overlay node-type 332 is used to extend the functionality of a node, such as the generic node 302, to incorporate processing logic. Unlike non-overlay nodes, an overlay node (e.g., a node having the overlay node-type 332) includes processing logic which determines the functionality of the overlay node. The processing logic of an overlay node includes a block of executable code, or instructions, which carries out one or more operations associated with the communication of data within the executable graph-based model 100. The block of executable code is pre-compiled code, code that requires interpretation at run-time, or a combination of both. Different overlay nodes provide different processing logic to realize different functionality. For example, an encryption overlay node includes an encryption technique using which an associated node is to be protected/secured and processing logic for facilitating such security/protection of the associated node. Throughout the description, the term overlay node is used herein for the generic overlay node and the tag overlay node, collectively.

The role node-type 334 defines a connective relationship between two nodes, for example, an edge node and a first vertex node. A node with the role node-type 334 defines a relationship without expressly defining the first vertex node to which the edge node connects. A number of roles (and thus a number of connections) that an edge node-type can have is not limited.

The one or more attributes 310 correspond to the data associated with the generic node 302 (e.g., the data represented by the generic node 302 within the executable graph-based model 100 as handled by the data management module 214). Notably, a node in the executable graph-based model 100 that is not associated with data may not have any attributes. The one or more attributes 310 represent a complex data type. Each attribute of the one or more attributes 310 is composed of an attribute behavior. Attribute behavior may be one of a standard attribute behavior, a reference attribute behavior, a derived attribute behavior, and a complex attribute behavior. The attribute behavior of each attribute defines the behavior of the corresponding attribute. The attribute behavior of each attribute may be configured by associated attribute configurations. The attribute configurations are examples of attribute configuration extensions which are node configuration extensions (e.g., they are part of the one or more node configuration extensions 324 of the generic node 302 shown in FIG. 3A). The standard attribute behavior may be configured by a standard attribute configuration, the reference attribute behavior may be configured by a reference attribute configuration, the derived attribute behavior is configured by a derived attribute configuration, and the complex attribute behavior is configured by a complex attribute configuration.

The attribute behavior defines the behavior of the corresponding attribute. The standard attribute behavior is a behavior that allows read-write access to the data of the corresponding attribute. The reference attribute behavior is a behavior that allows read-write access to the data of the corresponding attribute but restricts possible values of the data to values defined by a reference data set. The reference attribute configuration associated with the reference attribute behavior includes appropriate information to obtain a reference data set of possible values. The derived attribute behavior is a behavior that allows read-only access to data of the corresponding attribute. Also, data of the corresponding attribute is derived from other data or information, within the executable graph-based model 100 in which an executable node of the corresponding attribute is used. The data is derived from one or more other attributes associated with the node or is derived from more complex expressions depending on the application area. In one embodiment, the derived attribute configuration (which is used to configure the derived attribute behavior) includes mathematical and/or other forms of expressions (e.g., regular expressions, templates, or the like) that are used to derive the data (value) of the corresponding attribute. The complex attribute behavior is a behavior that allows the corresponding attribute to act as either a standard attribute behavior if the data of the corresponding attribute is directly set, or a derived attribute behavior if the data of the corresponding attribute is not directly set.

As shown, the generic node 302 further includes the metadata 312 (e.g., data stored as a name, a confidentiality indicator for indicating data as sensitive and/or confidential, an average processing time required for processing data, or the like) which is associated with either the generic node 302 or an attribute (for example, the one or more attributes 310) of the generic node 302. An attribute within the one or more attributes 310 may either have an independent state or a shared state. That is to say, an attribute may be a value-shared attribute or a non-value-shared attribute. An independent attribute has data that is not shared with any other node within the executable graph-based model 100. Conversely, a shared attribute has data that is shared with one or more other nodes within the executable graph-based model 100. For example, if two nodes within the executable graph-based model 100 comprise a shared-data attribute with a value state shared by both nodes, then updating the data (e.g., the value) of this shared attribute will be reflected across both nodes.

The node configuration 314 provides a high degree of configurations for the different elements of the generic node 302. The node configuration 314 optionally includes the one or more node configuration strategies 322 and/or the one or more node configuration extensions 324 which are complex data types. An example of a concrete node configuration strategy is an ID strategy, associated with the configuration of the unique ID 304a of the generic node 302, which creates message source IDs. A further example of a concrete node configuration strategy is a versioning strategy, associated with the configuration of the version ID 304b of the generic node 302, which supports major and minor versioning (depending on the type of transactional change incurred by the generic node 302). The versioning strategy may be adapted to a native filing system of a user device hosting the overlay system 202 or a third-party data storage (for example, Snowflake^{®}, or the like) associated with the overlay system 202.

The generic node 302 may be associated with a set of tags that may be applicable on one or more tag overlay nodes directly or indirectly associated therewith. The association of the set of tags with the generic node 302 is implemented by way of a tag container 336 that includes the set of tags (hereinafter, the set of tags 336a) associated with the generic node 302. Each tag of the set of tags 336a may be associated with a tag type, an execution criterion, and a tag configuration. Each tag of the set of tags 336a may be indicative of an execution approach of a tag overlay node with a tag overlay node-type that matches its tag type. Based on the matching of the tag overlay nod-type with the tag type of the tag, processing logic associated with the tag overlay node may be executed on the generic node 302 in conformity with the execution criterion indicated thereby and in accordance with the tag configuration of the tag. The tag configuration may be indicative of an operational technique such as an algorithm, a model, a function, or the like to be applied while executing the processing logic of the tag overlay node. In an example, the tag overlay node may be an audit overlay node. In such an example, a tag with audit tag type may match an audit overlay node-type of the audit overlay node. The tag may be associated with an execution criterion ‘include’. Therefore, the tag overlay node may be applicable on the generic node 302. Moreover, the tag configuration may be indicative of an operational technique being a first audit technique to be applied for auditing the generic node 302. Hence, the tag overlay node may be executed on the generic node 302 such that the processing logic of the tag overlay node applies the first audit technique while auditing the generic node 302. A tag being applicable on a tag overlay node means that a tag type of the tag may match a tag overlay node-type of the tag overlay node. Hence, the tag overlay node may be executed, on an associated node having the tag, in conformity with an execution criterion indicated by the tag.

The tag overlay node may be associated with the generic node 302 by way of a direct association or an indirect association. While being associated with the generic node 302 by way of the direct association, the tag overlay node may be associated with the generic node 302 without being associated with any intermediate node. On the contrary, while being associated with the generic node 302 by way of the indirect association, the tag overlay node may be associated with the generic node 302 via one or more intermediate nodes.

FIG. 3B is a block diagram 300B that illustrates a standard structure of a run-time node 338 within the executable graph-based model 100, consistent with disclosed embodiments of the present disclosure. Referring to FIG. 3B, the run-time node 338 corresponds to the core structure of the executable graph-based model 100 and forms the foundational building block for all data and processing logic within the executable graph-based model 100. The run-time node 338 is shown to include a node template 340 and a node instance 342. The node instance 342 is generated according to the node template 340. The node template 340 forms a data structure for the node instance 342. In other words, the node instance 342 is an implementation of the node template 340. The run-time node 338 shown in FIG. 3B is a compositional structure that is generated and executed, at run-time as part of the executable graph-based model 100. In other words, the node template 340 is defined as ‘offline’ and the node instance 342 and the run-time node 338 are run-time structures that are dynamically generated during execution of the executable graph-based model 100.

The node template 340 comprises a predetermined node structure. Further, the node template 340 defines one or more rules that govern the generation of the node instance 342. The node instance 342 is an implementation of the predefined node structure of the node template 340. In other words, the node instance 342 is generated based on the predetermined node structure and the one or more rules of the node template 340. The node template 340 cannot be modified during the execution but may be modified during offline mode or at rest. During execution, only the node instance 342 of the run-time node 338 may be modified.

The node template 340 includes properties 344, a node-type template 346, inheritance IDs 348, and a set of attribute templates 350. The node template 340 may optionally include metadata 352 and a node configuration 354. The properties 344 of the node template 340 include a unique identifier (ID) 344a, a version ID 344b, a namespace 344c, a name 344d, and optionally include one or more icons 344e and a set of labels 344f. The inheritance IDs 348 comprise an abstract flag 356, a leaf flag 358, and a root flag 360. The node configuration 354 optionally comprises one or more node configuration strategies 362 and/or one or more node configuration extensions 364.

FIG. 3B further shows a plurality of predetermined node-type templates 366 of the node-type template 346. The plurality of predetermined node-type template 366 includes a vertex node-type template 368, an edge node-type template 370, a role node-type template 372, an overlay node-type template 374, and a tag overlay node-type template 376. Further, the node instance 342 includes a unique ID 377, a version ID 378, a node-type instance 380, and a set of attribute instances 382. The node instance 342 may optionally include metadata 384. FIG. 3B further shows a plurality of predetermined node-type instances 386 of the node-type instance 380. The plurality of predetermined node-type instances 386 include a vertex node-type instance 388, an edge node-type instance 390, a role node-type instance 392, an overlay node-type instance 394, and a tag overlay node-type instance 396.

The unique ID 344a is unique for each node template within the executable graph-based model 100. Similarly, the unique ID 377 is unique for each node instance within the executable graph-based model 100. The unique ID 344a and the unique ID 377 are used to register, manage, and reference the node template 340 and the node instance 342, respectively, within the overlay system 202. The version ID 344b of the node template 340 is incremented when the node template 340 undergoes transactional change. Similarly, the version ID 378 of the node instance 342 is incremented when the node instance 342 undergoes transactional change. The namespace 344c of the node template 340, along with the name 344d of the node template 340, is used to help organize node templates within the executable graph-based model 100. That is, the node template 340 is assigned a unique name 344d within the namespace 344c such that the name 344d of the node template 340 need not be unique within the entire executable graph-based model 100, only within the context of the namespace 344c to which the node template 340 is assigned. The node template 340 optionally comprises one or more icons 344e which are used to provide a visual representation of the node template 340. The one or more icons 344e can include icons at different resolutions and display contexts such that the visualization of the node is adapted to different display contexts and settings. The node template 340 also optionally comprises the set of labels 344f which are used to override the name 344d when the node template 340 is rendered or visualized.

The node template 340 supports the software development feature of multiple inheritance by maintaining references (not shown) to zero or more other node templates, which then act as the base of the node template 340. This allows the behavior and functionality of a node template to be extended or derived from one or more other node templates within an executable graph-based model (such as the executable graph-based model 100). The node instance 342 likewise supports multiple inheritance because it is an instance representation of the node template 340. The multiple inheritance structure of the node instance 342 is, however, limited to the corresponding instance realization of the multiple inheritance structure defined by the node template 340, i.e., one node instance 342 is created and managed for each node template 340 defined in the inheritance hierarchy for a node instance of a node template.

The inheritance IDs 348 of the node template 340 provide an indication of the inheritance-based information, which is applicable, or can be applicable, to the node template 340. The inheritance IDs 348 have a description that is similar to the inheritance IDs 306. The abstract flag 356 has a description that is similar to the abstract flag 316, the leaf flag 358 has a description that is similar to the leaf flag 318, and the root flag 360 has a description that is similar to the root flag 320.

All elements within the executable graph-based model 100 are defined as node templates or node instances. The functionality of the node template 340 and the node instance 342 are realized due to the use of the node-type template 346 and the node-type instance 380. The node-type template 346 of the node template 340 is used to extend the functionality of the node template 340 by defining the standard set of capabilities, including data and associated behavior.

The vertex node-type template 368 (also referred to as a data node-type) includes a template of common data structures and functionality related to the ‘things’ modeled in the graph (e.g., the data). The vertex node-type instance 388 includes the common data structures and functionality related to the ‘things’ modeled in the graph based on the vertex node-type template 368. The edge node-type template 370 includes a template of common data structures and functionality related to joining two or more nodes. A node instance having the edge node-type instance 390 may connect two or more nodes and thus the edge node-type instance 390 constructs associations and connections between nodes (for example objects or ‘things’) within the executable graph-based model 100. The edge node-type instance 390 is not restricted to the number of nodes that can be associated or connected by a node having the edge node-type instance 390. The data structures and functionality of the edge node-type instance 390 thus define a hyper-edge which allows two or more nodes to be connected through a defined set of roles. A role defines a connective relationship between the two or more nodes, and hence, allows an edge node to connect two or more nodes such that the two or more nodes may have more than one relationship therebetween. The role node-type template 372 is used to define structure, conditions, or the like for establishing a connective relationship between two node instances or node templates. Similarly, the role node-type instance 392 is used to define a connective relationship between two node instances. The overlay node-type template 374 is used to extend the functionality of a node template (e.g., the node template 340) to incorporate processing logic. Similarly, the overlay node-type instance 394 is used to extend the functionality of a node instance (e.g., the node instance 342) to incorporate processing logic.

The tag overlay node-type template 376 is used to extend the functionality of a node template (e.g., the node template 340) to incorporate processing logic. The tag overlay node-type template 376 may define a template portion of a tag overlay node. Similarly, the tag overlay node-type instance 396 is used to extend the functionality of a node instance (e.g., the node instance 342) to incorporate processing logic. The tag overlay node-type instance 396 may define an instance portion of the tag overlay node. The tag overlay node associated with a run-time node (for example, the run-time node 338) may be a run-time node.

The set of attribute templates 350 corresponds to the data defined by the node template 340. For example, the set of attribute templates 350 may define the names and value types (e.g., integer, string, float, etc.) of one or more attributes but not the values of these attributes. The values of the set of attribute templates 350 may be defined by the set of attribute instances 382 of the node instance 342 through one or more values or instance values. For example, the node template 340 may define a string attribute ‘surname’ and the corresponding node instance 342 may assign the instance value ‘Bell-Richards’ to this string attribute. Each attribute instance of the set of attribute instances 382 is associated with an attribute template of the set of attribute templates 350. The node template 340 may define one or more default values for the set of attribute templates 350. The default values correspond to the values that the attributes take if no value is assigned. The metadata 352 (e.g., data stored as a name, a value type, and a value triplet) is associated with either the node template 340 or one or more of the set of attribute templates 350 of the node template 340. Similarly, the node instance 342 also optionally comprises the metadata 352 (e.g., data stored as a name, a value type, and a value triplet) which is associated with either the node instance 342 or one or more of the set of attribute instances 382.

The node configuration 354 provides a high degree of configurability for the different elements of a node template and/or a node instance. An example of a concrete node configuration strategy is an ID strategy, associated with the configuration of the unique ID 344a of the node template 340. A further example of a concrete node configuration strategy is a versioning strategy, associated with the configuration of the version ID 344b of the node template 340 which supports major and minor versioning (depending on the type of transactional change incurred). The versioning strategy may be adapted to a native filing system of a user device hosting the overlay system 202 or a third-party data storage (for example, Snowflake^{®}, or the like) associated with the overlay system 202.

Notably, a tag associated with the run-time node 338 may be a run-time tag and may include a tag template and a tag instance. As shown, the node template 340 may further include a tag template container 397 that may include a set of tag templates of a set of tags associated with the run-time node 338. Similarly, the node instance 342 may further include a tag instance container 398 that may include a set of tag instances of the set of tags associated with the run-time node 338. A set of tag templates of the set of tag templates along with a set of tag instances of the set of tag instances may form a set of tags associated with the run-time node 338. Each tag of the set of tags associated with the run-time node 338 may have a description similar to tags of the set of tags described in conjunction with FIG. 3A.

It will be apparent to a person skilled in the art that each node of the executable graph-based model 100 has a generic structure that is similar to the node 302 of FIG. 3A or the run-time node 338 of FIG. 3B.

Notably, a tag overlay node is itself an active node of the executable graph-based model 100. The tag overlay node may be a generic node or a run-time node. Based on the tag overlay node being the generic node, the tag overlay node may have a standard structure similar to the standard structure of the generic node 302 described in conjunction with FIG. 3A. Based on the tag overlay node being the run-time node, the tag overlay node may be a run-time tag overlay node and may have a standard structure similar to the standard structure of the run-time node 338 described in conjunction with FIG. 3B.

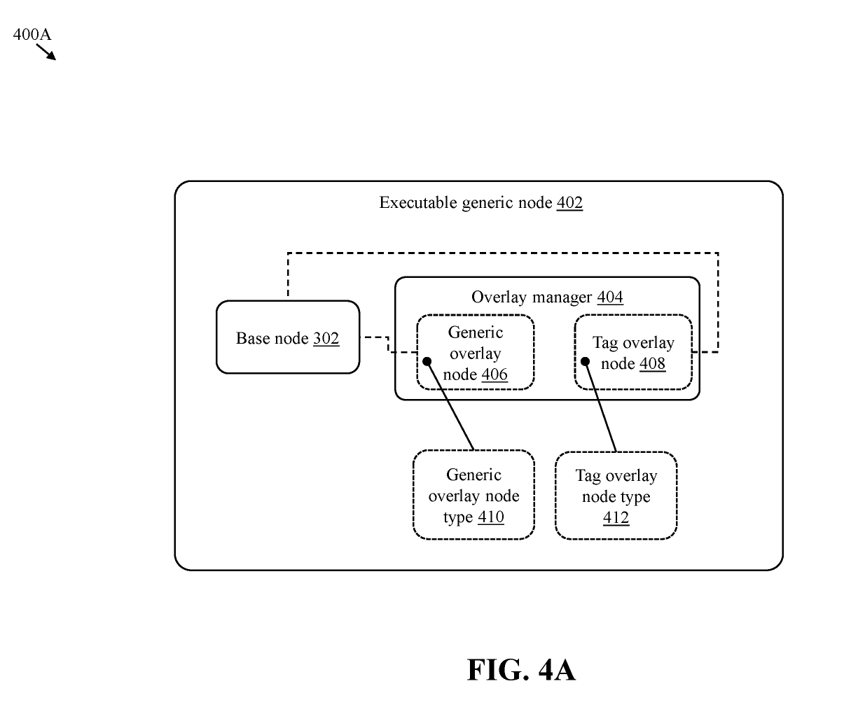

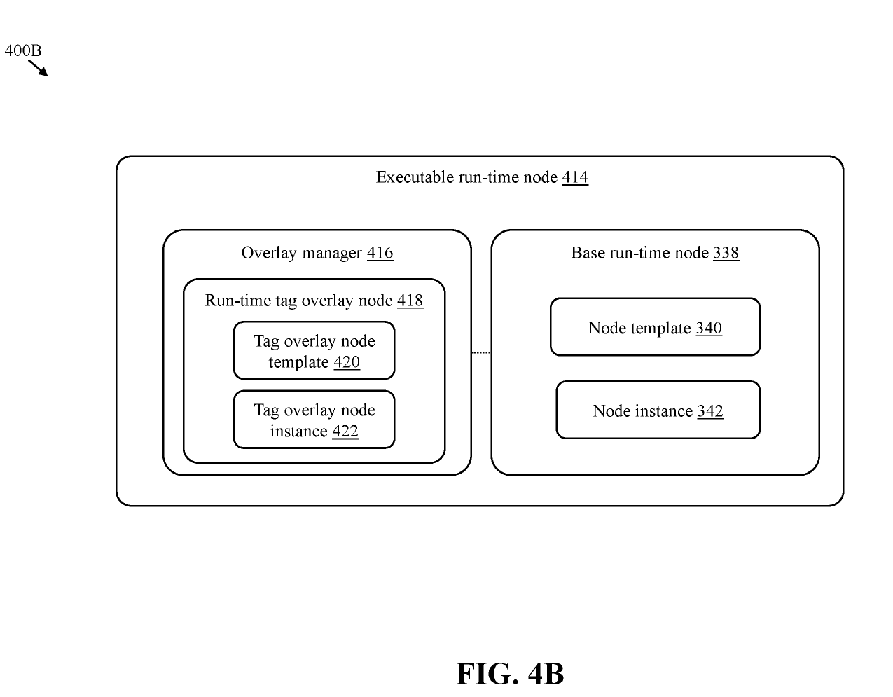

FIG. 4A is a block diagram 400A that illustrates an executable generic node 402 within the executable graph-based model 100, consistent with disclosed embodiments of the present disclosure. Referring to FIG. 4A, the executable generic node 402 is shown to include a base node (e.g., the generic node 302) and an overlay manager 404. For the sake of ongoing discussion, the base node corresponds to the generic node 302, and is hereinafter referred to as the “base node 302”. The base node 302 when extended by way of one or more overlay nodes becomes the executable generic node 402.

The overlay manager 404 includes a generic overlay node 406 and a tag overlay node 408. The executable graph-based model 100 may include a plurality of generic overlay nodes. Overlay nodes that are executable on an active node based on the association therewith are generic nodes. On the contrary, overlay nodes that are executable on an associated active node based on the association as well as a tag of the active node that has a tag type that matches a tag overlay node-type of the tag overlay node. The generic overlay node may be executed on an associated active node without a requirement to match a tag type of a tag associated with the active node. Notably, the tag overlay node-type may have a description similar to overlay node-type of an overlay node (for example, a generic overlay node).

The executable generic node 402 provides processing functionality (e.g., processing logic) to the base node 302 via one or more associated overlay nodes (for example, the overlay nodes 406 and 408). Beneficially, the data and processing capability of the base node 302 may be dynamically and significantly extended using the concept of an executable node (for example, the executable generic node 402). As shown, the generic overlay node 406 has a generic overlay node-type 410, and the tag overlay node 408 has a tag overlay node-type 412. The generic overlay node-type 410 may be same as the tag overlay node-type 412 except that the tag overlay node-type may match with a tag type of a tag associated with the base node 302. Examples of overlay node-type and the tag overlay node-type may include, but are not limited to, an encryption overlay node-type and a publisher overlay node-type.

A node with the encryption overlay node-type is an encryption overlay node that is indicative of an encryption technique using which an associated node is to be secured. The encryption overlay node also includes processing logic to secure a corresponding node. Examples of encryption techniques include a symmetric encryption algorithm, an asymmetric encryption algorithm, a combination of these, or any other encryption technique. A node with the publisher overlay node-type is a publisher overlay node that is indicative of an operation of publishing an output of an associated node. The publisher overlay node also includes processing logic to publish the output.

Although, the executable generic node 402 is shown to include the generic overlay node 406 and the tag overlay node 408, in other embodiments, the executable generic node 402 may include any number of overlay nodes, without deviating from the scope of the present disclosure. The generic overlay node 406 and the tag overlay node 408 are collectively referred to as overlay nodes 406 and 408.

The executable generic node 402 extends the base node 302 (or is a subtype of the base node 302) such that all the functionality and properties of the base node 302 are accessible to the executable generic node 402. The executable generic node 402 also dynamically extends the functionality of the base node 302 by associating the overlay nodes 406 and 408 maintained by the overlay manager 404 with the base node 302. The executable generic node 402 may thus be considered a combination of the base node 302 and the overlay nodes 406 and 408. The executable generic node 402 may be alternatively referred to as a node with overlay(s). Therefore, the executable generic node 402 acts as a decorator of the base node 302 adding the functionality of the overlay manager 404 to the base node 302.

It will be apparent to a person skilled in the art that the base node 302 refers to any suitable node within the executable graph-based model 100. As such, the base node 302 may be a node having a node-type such as a vertex node-type, an edge node-type, an overlay node-type, a role node-type, or the like. Alternatively, the base node 302 may be an executable node such that the functionality of the (executable) base node 302 is dynamically extended. In this way, complex and powerful processing functionality can be dynamically generated by associating and extending overlay nodes.

The overlay manager 404 registers and maintains one or more overlay nodes (such as the generic overlay node 406 and the tag overlay node 408) associated with the base node 302. The assignment of the overlay nodes 406 and 408 to the base node 302 (via the overlay manager 404) endows the base node 302 with processing logic and executable functionality defined within the overlay nodes 406 and 408.

Extending the functionality of a base node through one or more overlay nodes is at the heart of the overlay system 202. As illustrated in FIG. 2, the data (e.g., a vertex node as represented by the base node 302 in FIG. 4) and the functionality that acts upon that data (e.g., an overlay node) can be separated and independently maintained offline, but at run-time, an association between the data node and the overlay node is determined and an executable node is generated (e.g., the executable generic node 402 shown in FIG. 4A).

It will be apparent to a person skilled in the art that functionalities of the overlay nodes 406 and 408 may be performed by a single overlay node that includes processing logic associated with both of the overlay nodes 406 and 408.

It will be apparent to a person skilled in the art that the list of overlay types is not exhaustive and the number of different overlay types that can be realized is not limited. Because an overlay node is itself a node, all functionality of a node described in relation to the base node 302 is thus applicable to an overlay node. For example, an overlay node includes a unique ID, a name, etc., can have attributes (e.g., an overlay node can have its data defined), supports multiple inheritance, and can be configured via node configurations. Furthermore, because an overlay node is a node, the overlay node can have one or more overlay nodes associated therewith (e.g., the overlay node may be an overlay node with an overlay). Moreover, the processing functionality of an overlay node extends to the node-type of the node to which the overlay node is applied.

An overlay node, such as the generic overlay node 406 or the tag overlay node 408, is not bound to a single executable node or a single executable graph-based model (unlike nodes that have non-overlay node-types). This allows overlay nodes to be centrally managed and reused across multiple instances of executable graph-based models. Notably, a node (for example, a base node, an executable node, and an overlay node) may be extended by way of overlays. Further, each overlay node may be extended to have one or more overlays. Such overlays may be termed chaining overlays. Also, a single overlay node may be associated with multiple executable nodes. Thus, the overlay node and functionality thereof may be shared among the multiple executable nodes.

The overlay manager 404 of the executable generic node 402 is responsible for executing all overlays registered therewith. The overlay manager 404 also coordinates the execution of all associated overlay nodes. As shown in FIG. 4, the executable generic node 402 associates the base node 302 with two overlay nodes that is the generic overlay node 406 and the tag overlay node 408. Thus, the overlay manager 404 employs a strategy to manage the potentially cascading execution flow. Example strategies to manage the cascading execution of overlays include the visitor pattern and the pipe and filter pattern. Further examples include strategies that apply either breadth-first or depth-first processing patterns, a prioritization strategy, or a combination thereof. All execution strategies are defined and registered with the overlay manager 404 and are associated with an overlay via a node configuration extension for the overlay.

Because a tag overlay node is itself a node, all functionality of a node described in relation to the base node 302 is thus applicable to a tag overlay node. For example, an overlay node (for example, a generic overlay node and a tag overlay node) may include a unique ID, a name, etc., can have attributes (e.g., an overlay node can have its data defined), supports multiple inheritance, and can be configured via node configurations. Furthermore, because a tag overlay node is a node, the tag overlay node can have one or more generic overlay nodes or one or more tag overlay nodes associated therewith (e.g., the overlay node may be an overlay node with an overlay). Moreover, the processing functionality of a tag overlay node extends to the node type of the node to which the tag overlay node is applied.

FIG. 4A depicts a single overlay manager i.e., the overlay manager 404 that manages association of the base node 302 with each of the generic overlay node 406 and the tag overlay node 408. In some embodiments, the executable generic node 402 may include a generic overlay manager (not shown) that manages association of the base node 302 with the generic overlay node 406 and a tag overlay manager (not shown) that manages association of the base node 302 with the tag overlay node 408 without deviating from the scope of the disclosure.

FIG. 4B is a block diagram 400B that illustrates an executable run-time node 414 within the executable graph-based model 100, consistent with disclosed embodiments of the present disclosure. Referring to FIG. 4B, the executable run-time node 414 is shown to include the run-time node 338 (hereinafter referred to as ‘the base run-time node 338’) and an overlay manager 416. The overlay manager 416 may include a run-time overlay node 418. The executable run-time node 414 provides processing functionality (e.g., processing logic) to the base run-time node 338 via one or more associated overlay nodes (for example, a run-time tag overlay node 418). Beneficially, the data and processing capability of the base run-time node 338 may be dynamically and significantly extended using the concept of an executable run-time node (for example, the executable run-time node 414).

Although, the executable run-time node 414 is shown to include a single tag run-time overlay node (e.g., the run-time overlay node 406), in other embodiments, the executable run-time node 414 may include any number of run-time generic overlay nodes and/or run-time tag overlay nodes. Notably, a tag overlay node having a node template and a node instance is referred to as a run-time tag overlay node.

The executable run-time node 414 extends the base run-time node 338 (or is a subtype of the base run-time node 338) such that all the functionality and properties of the base run-time node 338 may be accessible to the executable run-time node 414. The executable run-time node 414 also dynamically extends the functionality of the base run-time node 338 by associating one or more run-time generic overlay nodes and one or more run-time tag overlay nodes maintained by the overlay manager 416 with the base run-time node 338. The executable run-time node 414 may thus be considered a composition of the base run-time node 338 and the run-time tag overlay node 418. The executable run-time node 414 may be alternatively referred to as a generic run-time node with overlay(s). Therefore, the executable run-time node 414 acts as a decorator of the base run-time node 338 adding the functionality of the overlay manager 416 to the base run-time node 338.

It will be apparent to a person skilled in the art that the base run-time node 338 refers to any suitable run-time node within the executable graph-based model 100. As such, the base run-time node 338 may be a generic run-time node having a node type such as a vertex node type, an edge node type, or the like. Alternatively, the base run-time node 338 may itself be an executable node such that the functionality of the (executable) base run-time node 338 is dynamically extended. In this way, complex and powerful processing functionality can be dynamically generated by associating and extending overlay nodes.

The overlay manager 416 registers and maintains one or more run-time generic overlay nodes and/or one or more run-time tag overlay nodes (such as the run-time tag overlay node 418) associated with the base run-time node 338. The assignment of the run-time tag overlay node 418 to the base run-time node 338 (via the overlay manager 416) endows the base run-time node 338 with processing logic and executable functionality defined within the run-time tag overlay node 418. In other words, the run-time tag overlay node 418 may interact at run-time, with the node template 340 and/or the node instance 342 of the base run-time node 338. In an example, the node template 340 and the node instance 342 may not be executable nodes. That is, neither the node template 340 nor the node instance 342 comprises an overlay manager with one or more run-time overlay nodes. In another example, the node template 340 and/or the node instance 342 may be executable nodes thereby extending the functionality, complexity, and configurability of executable run-time nodes.

Extending the functionality of a base run-time node through one or more run-time generic overlay nodes and/or the one or more run-time tag overlay nodes is at the heart of the overlay system 202. As illustrated in FIG. 2, the data (e.g., a vertex node as represented by the base node 302 in FIG. 4A) and the functionality that acts upon that data (e.g., an overlay node) can be separated and independently maintained offline, but at run-time, an association between the data node and the run-time generic overlay node and the run-time tag overlay node is determined and an executable run-time node is generated (e.g., the executable run-time node 414 shown in FIG. 4B). For the sake of brevity, FIG. 4B is described with respect to the run-time tag overlay node 418. It will be apparent to a person skilled in the art that a run-time generic overlay node may be associated and executed with the executable run-time node 338 in a similar manner.

Each run-time tag overlay node comprises a tag overlay node template 420 and a tag overlay node instance 422. The tag overlay node template 420 is a node template with the tag overlay node-type template 376. Similarly, the tag overlay node instance 422 is a node instance with the tag overlay node-type instance 396. The tag overlay node instance 422 is an implementation of the tag overlay node-type template 376. The tag overlay node template 420 comprises one or more rules that may be implemented by the processing logic of the tag overlay node instance 422. For example, a rule may be defined in a tag overlay node template specifying a hashing algorithm is to be used for indexing and a tag overlay node instance associated with the tag overlay node template provides a specific implementation of the hashing algorithm (e.g., Message-Digest Algorithm 5 (MD5), Secure Hash Algorithm-1 (SHA-1), SHA-2, etc.).

A run-time tag overlay node, such as the run-time tag overlay node 418, is a node having a tag overlay node-type assigned to its node type. Examples of tag overlay node-type include an encryption overlay node-type, an obfuscation overlay node-type, an audit overlay node-type, an analytics overlay node-type, a handler overlay node-type, a publisher overlay node-type, or the like. It will be apparent to a person skilled in the art that the list of tag overlay node-types is not exhaustive and the number of different tag overlay node-types that can be realized is not limited.

Because a run-time tag overlay node is itself a node, all functionality of a run-time node described in relation to the base run-time node 338 is thus applicable to a run-time overlay node. For example, an overlay node may include a unique ID, a name, etc., can have attributes (e.g., an overlay node can have its data defined), supports multiple inheritance, and can be configured via node configurations. Furthermore, because a tag overlay node is a node, the tag overlay node can have one or more generic overlay nodes or one or more tag overlay nodes associated therewith (e.g., the overlay node may be an overlay node with an overlay). Moreover, the processing functionality of a tag overlay node extends to the node type of the node to which the tag overlay node is applied.

A run-time tag overlay node, such as the run-time tag overlay node 418, is not bound to a single executable node or a single executable graph-based model (unlike nodes that have non-overlay node-types). This allows run-time overlay nodes to be centrally managed and reused across multiple instances of executable graph-based models. Notably, a node (for example, a base node, an executable node, and a tag overlay node) may be extended by way of overlays. Further, each overlay node may be extended to have one or more overlays. Such overlays may be termed chaining overlays.

Unlike non-run-time tag overlay nodes, a run-time tag overlay node may include processing logic (not shown in FIG. 4B) which determines the functionality of the run-time tag overlay node. The processing logic of a run-time tag overlay node may include a block of executable code, or instructions, which carries out one or more operations associated with the facilitation of indexing within the executable graph-based model 100. The block of executable code is pre-compiled code, code that requires interpretation at run-time, or a combination of both. Different run-time overlay nodes provide different processing logic to realize different functionality. The overlay manager 404 of the executable run-time node 414 is responsible for executing all overlays registered therewith. The overlay manager 416 also coordinates the execution of all associated overlay nodes. As shown in FIG. 4B, the executable run-time node 414 associates the base run-time node 338 with the run-time tag overlay node 418. A run-time tag overlay node and a run-time generic overlay node is collectively referred to as a run-time overlay node.

In some embodiments, the overlay manager 416 employs a strategy to manage potentially cascading execution flow of run-time overlays such that one overlay may be associated with one or more other overlays. Example strategies to manage the cascading execution of run-time overlays include the visitor pattern and the pipe and filter pattern. Further examples include strategies that apply either breadth-first or depth-first processing patterns, a prioritization strategy, or a combination thereof. All execution strategies may be defined and registered with the overlay manager 404 and may be associated with a run-time overlay via a node configuration extension for the run-time overlay.

To summarize, a node associated with a run-time overlay node is referred to as a run-time executable node. The run-time node and the run-time overlay node associated therewith may persist within the overlay system 202. The persistent nature of the data and the processing logic associated with an executable node (for example, a run-time node and a generic node) and an associated overlay node (e.g., generic overlay node, a run-time generic overlay node, a tag overlay node, or a run-time tag overlay node) are described in detail in conjunction with FIG. 5.

Throughout the description, an executable node is represented by way of two concentric circles. In other words, the executable node is represented by way of an inner circle encircled by an outer circle, where the incircle represents a base node and the outer circle represents an overlay node associated with the base node. Throughout the description, the terms ‘executable run-time node’ and ‘generic run-time node’ are, collectively, refer to as ‘executable node’.

FIG. 4B depicts a single overlay manager i.e., the overlay manager 416 that manages association of the base run-time node 338 with one or more run-time generic overlay nodes as well as one or more run-time tag overlay node (for example, the run-time tag overlay node 418). In some embodiments, the executable run-time node 414 may include a run-time generic overlay manager (not shown) that manages association of the base run-time node 338 with the one or more run-time generic overlay nodes and a run-time tag overlay manager (not shown) that manages association of the base run-time node 338 with the one or more run-time tag overlay nodes (for example, the run-time tag overlay node 418) without deviating from the scope of the disclosure.

FIG. 5 is a block diagram 500 that illustrates a composition of the executable generic node 402 that enables persistent storage of data and the processing logic associated therewith, consistent with disclosed embodiments of the present disclosure.

As described in conjunction with FIG. 4A, the executable generic node 402 includes the base node 302 and one or more overlay nodes (e.g., the overlay nodes 406 and 408). For the brevity of the ongoing description, the persistent storage is explained for the executable generic node 402 including only the tag overlay node 408. One or more operations performed for ensuring the persistence of the tag overlay node 408 may be performed for the generic overlay node 406 in a similar manner.

Referring to FIG. 5, the executable generic node 402 includes the base node 302 and the tag overlay node 408. The executable generic node 402 has a corresponding first state 502 having a first ID 504. The base node 302 has a second state 506 having a second ID 508, and the tag overlay node 408 has a third state 510 having a third ID 512. A manifest (for example, first through third manifests 514-518) is generated for each of the base node 302, the executable generic node 402, and the tag overlay node 408. In an embodiment, the manifests may be generated by the storage management module 220. The first manifest 514 is associated with the executable generic node 402 and has a fourth ID 520 and an overlay ID 522. The second manifest 516 is associated with the base node 302 and has a fifth ID 524. The third manifest 518 is associated with the tag overlay node 408 and has a sixth ID 526. Further, the manifests are stored at respective storage locations that may be centralized or distributed storage locations associated with the overlay system 202. The manifests may be stored by the storage management module 220.

The first state 502 of the executable generic node 402 includes data required to reconstruct the executable generic node 402 (e.g., attributes, properties, etc.). The first state 502 of the executable generic node 402 is persistently stored along with the first ID 504. The first manifest 514 is generated for the executable generic node 402 and has (i) the fourth ID 520 (which is the same as the first ID 504), (ii) the storage location of the first state 502 of the executable generic node 402, and (iii) the overlay ID 522 (which is the same as the sixth ID 526). Notably, the fourth ID 520 is the same as the first ID 504 and the fifth ID 524, hence, the first manifest 514 includes the ID of the state of the base node 302 and the executable generic node 402. Further, the overlay ID 522 is the same as the sixth ID 526 of the state of the tag overlay node 408. Therefore, the first manifest 514 may be used to identify and retrieve the states of the base node 302, the executable generic node 402, and the tag overlay node 408. Subsequently, the retrieved states may be used to reconstruct the executable generic node 402 and the tag overlay node 408. In an instance, the executable generic node 402 may be further extended to include additional overlay nodes. In such an instance, the first manifest 514 may include state IDs of the additional overlay nodes as well. A first manifest state (not shown) is then generated for the first manifest 514 and persistently stored along with the fourth ID 520.

The second state 506 of the base node 302 includes data required to reconstruct the base node 302 (e.g., attributes, properties, etc.) and is persistently stored along with the second ID 508. The second manifest 516 is generated for the base node 302 and has the fifth ID 524 and the storage location of the second state 506 of the base node 302. The second ID 508 of the second state 506 and the fifth ID 524 of the second manifest 516 are the same as the first ID 504 of the first state 502 of the executable generic node 402 (which is also the same as the fourth ID 520 of the first manifest 514 of the executable generic node 402). As mentioned above, along with the first state 502, the first manifest 514 may also be used to identify and retrieve the second manifest 516 which in turn may be used to identify the second state 506 of the base node 302. A second manifest state (not shown) is then generated for the second manifest 516 and persistently stored along with the fifth ID 524. Thus, the states, manifests, and manifest states for the executable generic node 402 and the base node 302 include the same, shared, ID. A shared ID can be used in this instance because the states, manifests, and manifest states are stored separately. The separate storage of the states, manifests, and manifest states exhibit a distributed architecture of the overlay system 202.

The third state 510 of the tag overlay node 408 includes data required to reconstruct the tag overlay node 408 (e.g., attributes, properties, processing logic, etc.) and is persistently stored along with the third ID 512. The third manifest 518 is generated for the tag overlay node 408 and includes the sixth ID 526, which is the same as the third ID 512. Therefore, the first manifest 514 may be further used to identify and retrieve the third manifest 518 which in turn may be used to identify and retrieve the third state 510 of the tag overlay node 408. A third manifest state (not shown) is then generated for the third manifest 518 and is persistently stored along with the sixth ID 526.

In operation, when the executable generic node 402 is to be loaded, the transaction module 208, in conjunction with the storage management module 220, may execute one or more operations to retrieve the first manifest state stored at a known storage location. Based on the first manifest state, the storage management module 220 may re-construct the first manifest 514 which includes the fourth ID 520 which is the same as the fifth ID 524 of the second manifest 516. Based on the fifth ID 524, the storage management module 220 may identify the second manifest state and may generate the second manifest 516 based on which the second state 506 is identified. Subsequently, the base node 302 is loaded and the storage management module 220 may determine that the base node is a node with overlay. Based on the fourth ID 520 (that is the same as the first ID 504 of the first state 502 of the executable generic node 402) of the first manifest 514, the first state 502 is identified and retrieved. Subsequently, the executable generic node 402 is loaded. Moreover, based on the overlay ID 522 (that is the same as the sixth ID 526 of the third manifest 518) of the first manifest 514, the third manifest state is identified and the third manifest 518 is generated. Subsequently, based on the sixth ID 526 (that is the same as the third ID of the third state) of the third manifest 518, the third state 510 is identified and retrieved. Based on the third state 510, the tag overlay node 408 is reconstructed and loaded in the executable graph-based model 100.

Based on a context of a stimulus (for example, the stimulus 230) associated with the overlay system 202, the processing logic (such as the context module 210) may determine an ID that is the same as the fifth ID 524. Based on the determined ID, the processing logic (such as the memory management module 218 and the storage management module 220) may identify the second manifest 516. Subsequently, the processing logic (such as the memory management module 218 and the storage management module 220) may identify the second state 506 that has the second ID 508 that matches the fifth ID 524. Further, the processing logic (such as the memory management module 218 and the storage management module 220) may retrieve the second state 506 associated with the second manifest 516 from a corresponding storage element. Subsequently, the processing logic (such as the memory management module 218 and the storage management module 220) may determine, by checking the manifest storage(s) associated with the overlay system 202, whether there is another manifest (such as the first manifest of the executable generic node 402) with an ID that matches the second ID 508 and the fifth ID 524. Notably, the first manifest 514 includes storage locations of each overlay node (for example, the tag overlay node 408) of the executable generic node 402. Based on the overlay ID 522 included in the first manifest 514 that matches the sixth ID 526 included in the third manifest 518, the processing logic (such as the memory management module 218 and the storage management module 220) may identify and retrieve the third manifest 518 from a manifest storage of a plurality of manifest storages of the overlay system 202. Subsequently, the processing logic (such as the memory management module 218 and the storage management module 220) may identify the third state 510 which has the third ID 512 that matches the sixth ID 526. Further, the processing logic (such as the memory management module 218 and the storage management module 220) may retrieve the third state 510 associated with the third manifest 518 from a corresponding storage element. To determine whether the tag overlay node 408 has an overlay node associated therewith, the processing logic (such as the memory management module 218 and the storage management module 220) may also perform a check to determine whether any of the plurality of manifest storages of the overlay system 202 includes any other manifest with an ID that matches the sixth ID 526. Since the tag overlay node 408 does not have an overlay associated therewith, no other manifest has the ID that matches the sixth ID.

Notably, the manifest (the third manifest 518) of the tag overlay node 408 includes a reference (such as an identifier that is common to the second manifest 516 and the third manifest 518, a link, a path, a storage location, or the like) to the second manifest 516 of the base node 302. Therefore, the re-formation of the executable generic node 402 includes a re-creation of the tag overlay node 408 prior to a re-creation of the base node 302. Subsequently, the tag overlay node 408 and the base node 302 are organized by associating the base node 302 with the tag overlay node 408 to re-form the executable generic node 402.

In some embodiments, the tag overlay node 408 may not be loaded in case it is not required for executing the operation associated with the stimulus 230. The loaded executable generic node 402 and the tag overlay node 408 may be unloaded in case they remain unused for a predefined time period, whereas one or more executable nodes that are used at least once during the predefined time period may remain loaded in the executable graph-based model 100. In some embodiments, the data and processing logic associated with a loaded executable node and/or overlay node may be transferred to a local memory of the overlay system 202 if the data and the processing logic remain unused for a first predefined period of time. Further, the data and the processing logic associated with the executable node/overlay node are transferred to an external storage from the local memory in case the executable node/overlay node remains unused for a second predefined period of time. The second predefined period of time is greater than the first predefined period of time. The term unloading refers to storing a state of a node with a current version of data and processing logic associated therewith at a storage location that is pointed by the corresponding manifest.

An executable graph-based model (for example, the executable graph-based model 100) may be stored (and loaded) using the above-described composition. Beneficially, each component is stored separately thereby allowing a user to maintain and store their data independently of the storage of the structure and functionality of the executable graph-based model 100.

Notably, the management and storage of manifests is managed by the controller module 206, the memory management module 218, the storage management module 220, a combination of these, or any other module of the overlay system 202. Also, all manifest states are stored together at a storage location (such as a manifest storage) that is known to the storage management module 220. Such centralized storage of the manifest states ensures that node states associated therewith are easily accessible.

It will be apparent to a person skilled in the art that although FIG. 5 illustrates only a single tag overlay node associated with a generic node, in other embodiments, the executable generic node 402 may include additional or different generic overlay nodes (for example, the generic overlay node 406) and/or tag overlay nodes. It will also be apparent to a person skilled in the art that only those overlay nodes that are required for responding to the stimulus 230 may be loaded in a manner similar to the loading of the tag overlay node 408.

In some embodiments, the executable run-time node 414 may be loaded by loading the node template 340 and the node instance 342. Each of the node template 340 and the node instance 342 may be loaded as described in conjunction with FIG. 5. Additionally, the node instance 342 may include a reference to the node template 340. Therefore, node template 340 may be identified based on the node instance 342 and may be loaded prior to the node instance 342.

Notably, as described in conjunction with FIGS. 3A and 3A, a set of tags associated with a generic node or a run-time node is a component of the standard structure of the generic node or the run-time node. Hence, based on the loading of the generic node or the run-time node corresponding set of tags may also get loaded. The processing circuitry (for example, the memory management module 218, the storage management module 220, or the like) may be configured to perform such loading of the generic node or the run-time node.

The overlay system 202 described in conjunction with FIGS. 1-5 is used to facilitate one or more operations associated with the tags and the tag overlay nodes in the executable graph-based model 100. Various concepts and features associated with the tags and the tag overlay nodes are described later in the description in detail.

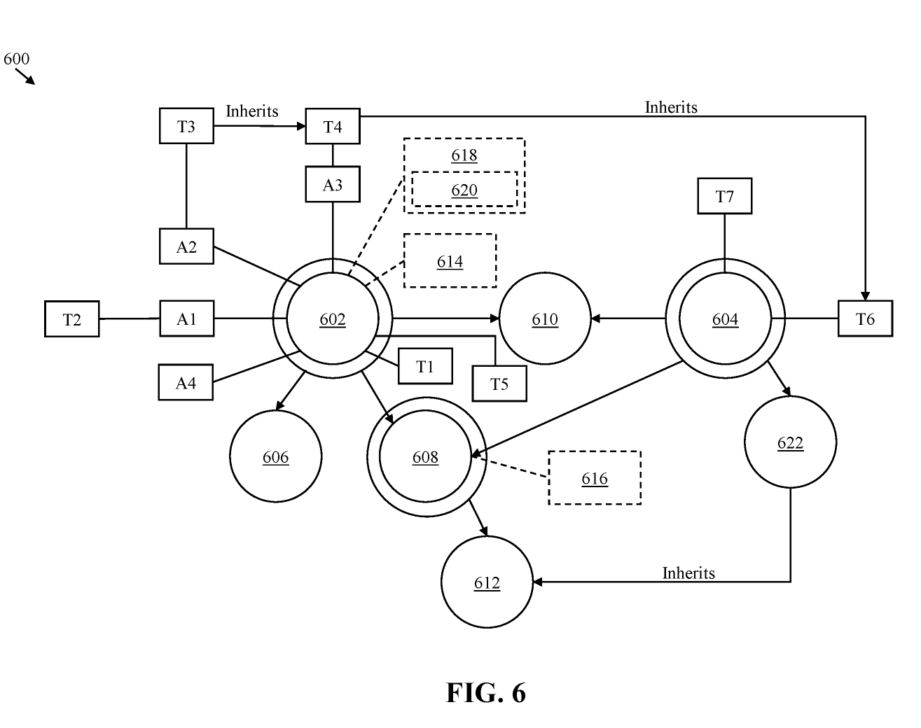

As described previously, the plurality of active nodes may include generic nodes and run-time nodes. Each of the plurality of active nodes may be associated with the set of tags and the tag overlay nodes. FIGS. 6-8 describe various features associated with the implementation of tags and tag overlay nodes in the overlay system 202.

FIG. 6 is a graph 600 that depicts an implementation of tags and tag overlay nodes in association with generic nodes of the executable graph-based model 100, consistent with disclosed embodiments of the present disclosure. Referring to FIG. 6, shown are a plurality of active nodes including generic nodes 602 and 604. The generic node 602 is shown to include a plurality of node elements. The plurality of node elements may be composed of components of a standard structure of a generic node (for example, the generic node 302). For the sake of brevity, the plurality of node elements associated with the generic node 602 are shown to include attributes A1, A2, A3, and A4. The generic node 602 is shown to be associated with a generic overlay node 606 and tag overlay nodes 608 and 610. The tag overlay node 608 is shown to be further associated with an overlay node 612. The overlay node 612 may be a generic overlay node or a tag overlay node.

The generic node 602 is further shown to include an overlay manager 614. The overlay manager 614 may have a description similar to the overlay manager 404 depicted in FIG. 4A. The overlay manager 614 may be configured to manage association of the generic node 602 with the generic overlay node 606 and the tag overlay nodes 608 and 610. Similarly, the tag overlay node 608 may include an overlay manager 616 having a description similar to the overlay manager 404 depicted in FIG. 4A. The overlay manager 616 may be configured to manage association of the tag overlay node 608 with the overlay node 612.

As shown, the generic node 604 is also associated with the tag overlay nodes 608 and 610. Therefore, the tag overlay nodes 608 and 610 are shared among the generic nodes 602 and 604. In other words, processing logic associated with the tag overlay nodes 608 and 610 may be executed on each of the generic nodes 602 and 604.

Moreover, the generic node 602 includes a tag container 618 that includes a set of tags 620 associated with the generic node 602. The set of tags 620 may include one or more tags that may have tag types that match tag overlay node-types of one or more tag overlay nodes directly or indirectly associated with the generic node 602. In an example, a tag type of a tag of the set of tags 620 may be ‘audit tag’. In such an example, the tag type ‘audit tag’ may match a tag overlay node-type ‘audit overlay node-type’ of a tag overlay node that may be an audit overlay node. The set of tags 620 may include tags T1, T2, T3, T4, and T5. Similarly, the generic node 604 may have a tag container (not shown) including a set of tags associated therewith. The set of tags associated with the generic node 604 may include tags T6 and T7.

Various examples of a tag type of a tag may include, but are not limited to, a categorical tag, a temporal tag, a geospatial tag, a user-defined tag, a functional tag, a status tag, a quality tag, a security tag, a relationship tag, a role-based tag, an event tag, a topic/subject tag, a usage tag, a lifecycle tag, a metadata tag, and a custom attribute tag. Notably, the tag type of the tag associated with an active node may depend on nature of data stored in association with the active node and/or a goal of an operation to be performed using the active node. Beneficially, application of tags in the executable graph-based model 100 enhances the semantic richness of the executable graph-based model 100, making it more descriptive and facilitating better organization and understanding of data and/or processing logic stored therein.

The tag with the tag type ‘categorical tag’ may be a descriptive label that categorizes an associated active node into one or more predefined groups or classes. Examples of the categorical tag may include a person tag, a company tag, a product tag, or the like.

The tag with the tag type ‘temporal tag’ may be indicative of temporal information such as timestamps or date ranges. Such a tag may be useful for various time constrained/related purposes such as tracking a timeline of updates/changes made to information associated with the active node.

The tag with the tag type ‘geospatial tag’ may provide geographical information related to the active node. Examples of the tag with the tag type ‘geospatial tag’ may include a country name tag, a city name tag, or a coordinates tag.

The tag with the tag type ‘user-defined tag’ may be a customized tag created by a user of the active node based on specific needs or preferences. The user may associate the tag to one or more active nodes to represent concepts relevant to an analysis of the one or more active nodes.

The tag with the tag type ‘functional tag’ may be indicative of a role or a function of the active node within the overlay system 202 or within an operation associated with the overlay system 202. Examples of the tag with the tag type ‘functional tag’ include a customer tag, a supplier tag, or an employee tag.

The tag with the tag type ‘status tag’ may be indicative of a status or a state of the associated active node. Examples of the tag with the tag type ‘status tag’ may include an active tag, an inactive tag, or a pending approval tag.

The tag with the tag type ‘quality tag’ may provide information about data quality associated with the active node. The tag with the tag type ‘quality tag’ may indicate whether data associated with the active node is verified, estimated, or requires validation. Examples of the tag with the tag type ‘quality tag’ may include a verified tag, an estimated tag, or a requires validation tag.

The tag with the tag type ‘security tag’ may indicate a security level or sensitivity of the data associated with the active node. The tag with the tag type ‘security tag’ may be useful for managing access control and confidentiality of the data associated with the active node.

The tag with the tag type ‘relationship tag’ may specify a type or nature of relationships between one or more active nodes associated therewith. Examples of the tag with the tag type ‘relationship tag’ may include a friend tag, a colleague tag, or a parent tag.

The tag with the tag type ‘role-based tag’ may be indicative of a role or position of the active node within the overlay system 202 or within an operation associated with the overlay system 202. Examples of the tag with the tag type ‘role-based tag’ may include an administrator tag, a moderator tag, or a contributor tag.

The tag with the tag type ‘event tag’ may be indicative of one or more active nodes associated therewith being related to one or more specific events within the overlay system 202. Examples of the tag with the tag type ‘event tag’ may include a conference tag, a product launch tag, or an anniversary tag.

The tag with the tag type ‘topic/subject tag’ may indicate a primary topic or subject of the active node. Such a tag may be useful for content-based graphs, such as tagging articles with topics like technology, health, or finance. Examples of the tag with the tag type ‘topic/subject tag’ may include a technology tag, a health tag, or a finance tag.

The tag with the tag type ‘usage tag’ may be indicative of information about use and/or purpose of the active node. Examples of the tag with the tag type ‘usage tag’ may include a primary contact tag, a billing address tag, or a shipping location tag.

The tag with the tag type ‘lifecycle tag’ may represent a stage or a phase of the active node within its lifecycle. Examples of the tag with the tag type ‘lifecycle tag’ may include tags such as a new tag, an in-progress tag, or a completed tag.

The tag with the tag type ‘metadata tag’ may provide additional metadata information about the active node. Examples of the tag with the tag type ‘metadata tag’ may include an author tag, a creation date, or a version tag.

The tag with the tag type ‘custom attribute tag’ may represent custom attributes specific to a domain or application of the active node. The users of the overlay system 202 may define and apply the tag with one or more active nodes based on their unique requirements.

A first tag may be associated with a first active node (for example, the generic nodes 302, 602, 604, and the run-time node 338) by way of a node level association or a node element level association. The first tag associated with the first active node by way of the node level association may also be associated with each node element of the first active node unless the association with the first tag is overridden by a second tag associated with a node element and having a tag type that may be same as a tag type of the first tag. In an instance, the first active node may be a parent node of a second active node. In such an instance, the first tag may also be associated with the second active node unless the association with the first tag is overridden by a third tag associated with the second active node and having a tag type that may be same as the tag type of the first tag. Further, the first tag associated with the first active node by way of a node element level association may be associated with one or more node elements of the plurality of node elements of the first active node. Therefore, the first tag may not be applicable on remaining node elements of the plurality of node elements of the first active node.

As shown, the tags T1 and T5 are associated with the generic node 602 by way of the node level association whereas the tags T2, T3, and T4 are associated with the generic node 602 by way of the node element level association. The tags T1 and T2 have same tag type. The tag type of the tags T1 and T2 matches a tag overlay node-type of the tag overlay node 608. Notably, the tag T1 is associated with the generic node 602 by way of the node level association by being directly associated with therewith whereas the tag T2 is associated with the generic node 602 by way of the node element level association by being associated with the attribute A1 of the generic node 602. Therefore, the tag T1 may be applicable on each of the plurality of node elements of the generic node 602 except for the attribute A1. Further, the tags T3, T4, and T5 may have same tag type. The tag T5 is associated with the generic node 602 by way of the node level association by being directly associated therewith whereas the tags T3 and T4 may be associated with the generic node 602 by way of the node element level association by being associated with the attributes A2 and A3, respectively. The tags T3, T4, and T5 may have tag types that may match a tag overlay node-type of the tag overlay node 610. Therefore, the tag T5 may be applicable on each of the plurality of node elements of the generic node 602 except for the attributes A2 and A3. The tags T3 and T4 may be applicable of the attributes A2 and A3, respectively.

In some embodiments, a tag may inherit from another tag associated with a common active node or a different active node. In an instance, the tag T3 may inherit from the tag T4. For example, the tag type of the tags T3 and T4 may be ‘audit tag’. In such an example, the tag T4 may include a tag configuration indicative of an operational technique being an audit technique. Based on the tag T3 inheriting the tag T4, the tag T3 may also include a tag configuration indicative of an operational technique being the audit technique. In another instance, the tag T4 may inherit from the tag T6. For example, the tag T6 may include a tag configuration indicative of an operational technique being time constraint for auditing of the generic node 604. Based on the tag T4 inheriting from the tag T6, the tag T4 may also include a tag configuration indicative of an operational technique being the time constraint for auditing of the attribute A3.

In operation, the processing circuitry (for example, the controller module 206, the transaction module 208, or the like) may receive a first stimulus (for example, the stimulus 230) associated with the overlay system 202. The processing circuitry (for example, the controller module 206, the transaction module 208, the stimuli management module 212, or the like) may be configured to identify, based on a context of the first stimulus, the generic node 602 of the plurality of active nodes shown in FIG. 6. The processing circuitry (for example, the controller module 206, the transaction module 208, the stimuli management module 212, or the like) may be configured to determine, based on the context of the first stimulus, the tag overlay node 608 associated with the generic node 602. In some embodiments, the tag overlay node 608 may be determined based on the association with the generic node 602. The processing circuitry (for example, the controller module 206, the transaction module 208, the stimuli management module 212, or the like) may be further configured to determine the tag overlay node-type of the tag overlay node 608. The processing circuitry (for example, the controller module 206, the transaction module 208, the stimuli management module 212, or the like) may be configured to determine the tag overlay node 608 and the tag overlay node-type thereof based on processing logic of the tag overlay node 608 being in conformity with the first stimulus. That is to say that an operation to be performed for processing the first stimulus (for example, the stimulus 230) may be executable by processing logic/functionality of the tag overlay node 608.

Subsequently, the processing circuitry (for example, the controller module 206, the transaction module 208, or the like) may be configured to determine a tag of the set of tags 620 that has a tag type which matches the tag overlay node-type of the tag overlay node 608. The processing logic (for example, the controller module 206, the transaction module 208, or the like) may be configured to use the tag overlay node 608 to determine the tag of the set of tags 620 that has the tag type which matches the tag overlay node-type thereof. Notably, the tag overlay node 608 may include processing logic and implementation logic. The processing logic may correspond to a functionality associated with the tag overlay node 608. The implementation logic may correspond to a pre-execution task associated with the tag overlay node 608. The pre-execution task may be executed prior to execution of the processing logic associated with the tag overlay node 608 to determine the tag of the set of tags 620 that has the tag type which matches the tag overlay node-type of the tag overlay node 608. The processing circuitry (for example, the controller module 206, the transaction module 208, or the like) may be configured to use the implementation logic of the tag overlay node 608 to determine the tag of the set of tags 620 that has the tag type which matches the tag overlay node-type of the tag overlay node 608. The processing logic (for example, the controller module 206, the transaction module 208, or the like) may be configured to execute the implementation logic of the tag overlay node 608 on the set of tags 620 to determine the tag of the set of tags 620 that has the tag type which matches the tag overlay node-type of the tag overlay node 608. For such determination of the tag that matches the tag overlay node-type of the tag overlay node 608, the processing circuitry (for example, the controller module 206, the transaction module 208, or the like) may be configured to retrieve the set of tags 620 associated with the generic node 602. Subsequently, the processing circuitry (for example, the controller module 206, the transaction module 208, or the like) may be configured to compare the tag overlay node-type of the tag overlay node 608 with a tag type of each tag of the set of tags 620. Based on the comparison, the processing circuitry (for example, the controller module 206, the transaction module 208, or the like) may be configured to determine the tag T1 has the tag type which matches the tag overlay node-type of the tag T1.

The processing circuitry (for example, the controller module 206, the transaction module 208, or the like) may be configured to execute, in response to the first stimulus, a first operation based on the generic node 602 and the tag overlay node 608. The first operation may be executed based on a first execution criterion indicated by the tag T1. The first operation may be further executed based on a tag configuration associated with the tag T1 such that the tag configuration may be indicative of an operational technique. The operational technique may correspond to a model, an algorithm, an equation, a function, or the like to be applied while executing the processing logic of the tag overlay node 608.

In an instance, the tag overlay node 608 may have a tag overlay node-type ‘an encryption overlay node-type’. The tag overlay node 608 may include an encryption logic as well as a decryption logic. In such an example, the tag T1 may have a tag type ‘encryption tag’. The tag type ‘encryption tag’ may match the tag overlay node-type ‘encryption overlay node-type’ of the tag overlay node 608. The tag T1 may be indicative of an execution criterion ‘include’ (namely, being applicable) or ‘exclude’ (namely, not being applicable) that may be indicative of inclusion or exclusion, respectively, of the generic node 602 from application of the encryption logic or the decryption logic of the tag overlay node 608. For the sake of the ongoing example, it is assumed that the execution criterion may be ‘include’. Therefore, the first operation may be executed based on with the execution criterion being ‘include’ for the generic node 602. That is to say that the tag overlay node 608 may be executed on the generic node 602. Additionally, the tag T1 may have a tag configuration indicative of an operational technique being a first encryption technique that may be applied while executing the encryption logic of the tag overlay node 608 on the generic node 602. In some embodiments, the tag T1 may be indicative of an execution criterion specific to the encryption logic of the tag overlay node 608. In such embodiments, the generic node 602 may have an additional tag having another execution criterion that may be specific to the decryption logic of the tag overlay node 608. The additional tag may have a corresponding execution criterion being ‘include’ or ‘exclude’. In an example, based on the execution criterion associated with the tag T1 being ‘include’, the execution criterion associated with the additional tag may also be ‘include’. Similarly, based on the execution criterion associated with the tag T1 being ‘exclude’, the execution criterion associated with the additional tag may also be ‘exclude’. The additional tag may also have a tag configuration indicative of a first decryption technique to be while executing the decryption logic of the tag overlay node 608 on the generic node 602.

As mentioned previously, the tag T1 is associated with the generic node 602 by way of the node level association. The processing circuitry (for example, the controller module 206, the transaction module 208, or the like) may be configured to determine that each of the attributes A2, A3, and A4 has an absence of an associated tag with a tag type that matches the tag overlay node-type of the tag overlay node 608. Based on such an absence, the processing circuitry (for example, the controller module 206, the transaction module 208, or the like) may be configured to associate the tag T1 with each of the attributes A2, A3, and A4. Subsequently, the first operation is executed further based on the attributes A2, A3, and A4 and in conformity with the first execution criterion and the tag configuration associated with the tag T1. Further, the processing circuitry (for example, the controller module 206, the transaction module 208, or the like) may determine that the attribute A1 is associated with the tag T2 by way of the node element level association such that the tag T2 may have a tag type that matches with the tag overlay node-type of the tag overlay node 608. Hence, the tag T1 may be overridden by the tag T2 associated with the attribute A1. Hence, the first operation may be executed further in conformity with a second execution criterion associated with the tag T2. It is assumed that the second execution criterion may be ‘exclude’. Hence, the attribute A1 may be excluded from the execution of the first operation in accordance with the second execution criterion.

The processing circuitry (for example, the controller module 206, the transaction module 208, or the like) may further determine that the tag overlay node 608 is associated with the overlay node 612. The overlay node 612 extends a functionality of the tag overlay node 608. Based on such determination, the processing circuitry (for example, the controller module 206, the transaction module 208, or the like) may be further configured to execute the first operation based on the overlay node 612. This summarizes processing of the first stimulus.

In some embodiments, upon identifying the generic node 602 and the tag overlay node 608, the processing circuitry (for example, the controller module 206, the transaction module 208, or the like) may be further configured to determine whether the generic node 602 and the tag overlay node 608 are loaded in the executable graph-based model 100. Based on the generic node 602 and/or the tag overlay node 608 being unloaded from the executable graph-based model 100, the processing circuitry (for example, the controller module 206, the transaction module 208, or the like) may be further configured to load the generic node 602 and/or the tag overlay node 608 in the executable graph-based model 100. The processing circuitry (for example, the controller module 206, the transaction module 208, or the like) may be further configured to load the generic node 602 and/or the tag overlay node 608 as described in conjunction with FIG. 5. In addition, since the set of tags 620 is included within the standard structure of the generic node 602, the set of tags 620 may also be loaded in association with the generic node 602.

Subsequently, upon processing of the first stimulus, the processing circuitry (for example, the controller module 206, the transaction module 208, or the like) may be further configured to unload the generic node 602 and/or the tag overlay node 608 from the executable graph-based model 100. The set of tags 620 may also be unloaded from the executable graph-based model 100 in association with the generic node 602.

The processing circuitry (for example, the controller module 206, the transaction module 208, or the like) may be further configured to receive a second stimulus (for example, the stimulus 230) associated with the overlay system 202. The processing circuitry (for example, the controller module 206, the transaction module 208, the stimuli management module 212, or the like) may be configured to determine, based on a context of the second stimulus, the generic node 602. The processing circuitry (for example, the controller module 206, the transaction module 208, the stimuli management module 212, or the like) may be configured to determine, based on the context of the second stimulus, the tag overlay node 610 associated with the generic node 602. In some embodiments, the tag overlay node 610 may be identified based on the association with the generic node 602.

The processing circuitry (for example, the controller module 206, the transaction module 208, or the like) may be configured to determine the tag T5 of the set of tags 620 having the tag type that matches the tag overlay node-type of the tag overlay node 610. The determination of the tag T5 may be performed in a manner similar to determination of the tag T1. The processing circuitry (for example, the controller module 206, the transaction module 208, or the like) may be configured to determine that the tag T5 is associated with the generic node 602 by way of the node level association. The processing circuitry (for example, the controller module 206, the transaction module 208, or the like) may be further configured to determine that the tag T5 is being overridden by the tags T3 and T4 associated with the attributes A2 and A3, respectively. The processing circuitry (for example, the controller module 206, the transaction module 208, or the like) may be configured to determine that tag T5 is being overridden by the tags T3 and T4 in a manner similar to the determination of the tag T1 being overridden by the tag T2.

The overriding of the tag T5 may be applicability-based or tag configuration-based. In an instance, the overring of the tag T5 by the tags T3 and T4 may be applicability-based. In such an instance, a tag overlay node with a tag overlay node-type that matches the tag type of the tag T5, may be applicable i.e., executable on the generic node 602 based on the execution criterion of the tag T5, however, based on execution criterion of the tags T3 and T4, the tag overlay node may not be executable on the attributes A2 and A3, respectively. In another instance, the overriding of the tag T5 by the tags T3 and T4 may be tag configuration-based. In such an instance, a tag overlay node with a tag overlay node-type that matches the tag type of the tag T5, may be applicable i.e., executable on the generic node 602 based on the tag configuration (for example, a first encryption technique) of the tag T5. In some embodiments, the tags T3 and T4 may not have an execution criterion hence, the execution criterion of the tag T5 may be applicable to the attributes A2 and A3. Additionally, the tags T3 and T4 may have corresponding tag configurations. Therefore, the tag overlay node may be executable on the attributes A2 and A3, respectively based on the tag configurations (for example, a second encryption technique and a third encryption technique, respectively) of the tags T3 and T4, respectively.

Subsequently, the processing circuitry (for example, the controller module 206, the transaction module 208, or the like) may be configured to execute, in response to the second stimulus, a second operation based on the generic node 602 and the tag overlay node 610. The attributes A1 and A4 may not have a node element level association with a tag having a tag type that matches the tag overlay node-type of the tag overlay node 610. Therefore, the second operation may be executed on the attributes A1 and A4 based on the tag T5. That is to say that the second operation is executed on the attributes A1 and A4 in conformity with a third execution criterion and tag configuration indicated by the tag T5 in a manner similar to the execution of the first operation based on the tag T1. The second operation may be further executed based on the attributes A2 and A3 in accordance with execution criteria and/or tag configurations indicated by the tags T3 and T4 respectively, in a manner similar to the execution of the first operation based on the attribute A1 and the tag T2.

In addition, the second operation may be executed based on the tag T3 inheriting from the tag T4 and the tag T4 inheriting from the tag T6 associated with the generic node 604. Further, based on the tag T4 inheriting from the tag T6, the tag T6 may be required for application of the tag T4. Therefore, based on the tag T4 inheriting from the tag T6 associated with the generic node 604, the generic node 604 may be loaded based on the loading of the generic node 602.

The processing circuitry (for example, the controller module 206, the transaction module 208, or the like) may be further configured to receive a third stimulus (for example, the stimulus 230) associated with the overlay system 202. The processing circuitry (for example, the controller module 206, the transaction module 208, the stimuli management module 212, or the like) may be configured to determine, based on a context of the third stimulus, the generic node 604 of the plurality of active nodes shown in FIG. 6. The processing circuitry (for example, the controller module 206, the transaction module 208, the stimuli management module 212, or the like) may be configured to determine, based on the context of the third stimulus, the tag overlay node 608 associated with the generic node 604. In some embodiments, the tag overlay node 608 may be identified based on the association with the generic node 604.

The processing circuitry (for example, the controller module 206, the transaction module 208, the stimuli management module 212, or the like) may be configured to retrieve the set of tags associated with the generic node 604. The processing circuitry (for example, the controller module 206, the transaction module 208, the stimuli management module 212, or the like) may be configured to determine the tag T7 from the retrieved set of tags. The tag T7 may have a tag type matching the tag overlay node-type of the tag overlay node 608. The processing circuitry (for example, the controller module 206, the transaction module 208, the stimuli management module 212, or the like) may determine the tag T7 in a manner similar to the determination of the tag T1. The processing circuitry (for example, the controller module 206, the transaction module 208, the stimuli management module 212, or the like) may further determine that the tag T7 is not being overridden by any other tag of the retrieved set of tags. The processing circuitry (for example, the controller module 206, the transaction module 208, the stimuli management module 212, or the like) may be further configured to execute a third operation in a manner similar to the execution of the first operation. The third operation may be executed in conformity with a third execution criterion indicated by the tag T7. The third operation may be executed further based on a tag configuration associated with the tag T7.

In some embodiments, the generic node 604 may be further associated with an overlay node 622. The overlay node 622 may be a generic overlay node or a tag overlay node. The overlay node 622 may include a functionality that may have to be used for one or more node elements of the generic node 602. In such an instance, the tag overlay node 608 may inherit from the overlay node 622. The functionality inherited by the tag overlay node 608 may be executed on the one or more node elements of the generic node 602 based on tag configuration and operational functionalities of one or more tags associated with the generic node 602 at node level or node element level. In another instance, the overlay node 622 may be a tag overlay.

For the sake of brevity, FIG. 6 depicts the plurality of node elements associated only with the generic node 602. It will be apparent to a person skilled in the art that the generic node 604 may be similarly associated with a corresponding plurality of node elements.

It will be apparent to a person skilled in the art that various concepts described in conjunction with the generic node 602 may also be applicable to the generic node 604.

Having discussed the implementation of tags and tag overlay nodes in association with active nodes that may be generic node, the description now moves towards implementation of tag and tag overlay nodes in association with active nodes that may be run-time nodes.

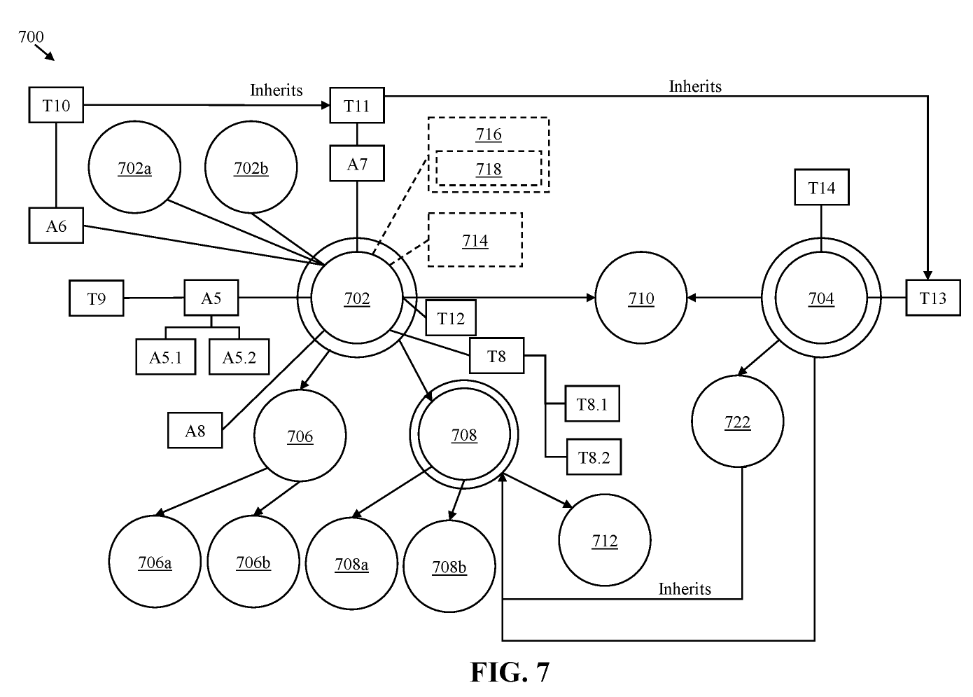

FIG. 7 is a graph 700 that depicts an implementation of tags and tag overlay nodes in association with run-time nodes of the executable graph-based model 100, consistent with disclosed embodiments of the present disclosure. Referring to FIG. 7, shown are a plurality of active nodes including run-time nodes 702 and 704. The run-time node 702 includes a node template 702a and a node instance 702b. Although not shown, the run-time node 704 may also include a node template and a node instance. The run-time node 702 is shown to include a plurality of node elements. The plurality of node elements may be composed of components of a standard structure of a run-time node (for example, the run-time node 338). For the sake of brevity, the plurality of node elements associated with the run-time node 702 are shown to include attributes A5, A6, A7, and A8. Each of the attributes A5, A6, A7, and A8 may include an attribute template and an attribute instance. For example, the attribute A5 is shown to include an attribute template A5.1 and an attribute instance A5.2. The run-time node 702 is shown to be associated with a run-time overlay node 706 including an overlay node template 706a and an overlay node instance 706b. The run-time node 702 is further associated with run-time tag overlay nodes 708 and 710. The run-time tag overlay nodes 708 and 710 may include corresponding node templates and corresponding node instances. For example, the run-time tag overlay node 708 is shown to include a node template 708a and a node instance 708b. The run-time tag overlay node 708 is shown to be further associated with a run-time overlay node 712. The run-time overlay node 712 may be a run-time overlay node or a run-time tag overlay node.

The run-time node 702 is further shown to include an overlay manager 714. The overlay manager 714 may have a description similar to the overlay manager 416 depicted in FIG. 4B. The overlay manager 714 may be configured to manage association of the run-time node 702 with the run-time overlay node 706 and the run-time tag overlay nodes 708 and 710. Similarly, the run-time tag overlay node 708 may include an overlay manager (not shown) having a description similar to the overlay manager 416 depicted in FIG. 4B. The overlay manager may be configured to manage association of the run-time tag overlay node 708 with the run-time overlay node 712.

As shown, the run-time node 704 is also associated with the run-time tag overlay nodes 708 and 710. Therefore, the run-time tag overlay nodes 708 and 710 are shared among the run-time nodes 702 and 704. Processing logic associated with the run-time tag overlay nodes 708 and 710 may be executed on each of the run-time nodes 702 and 704.

Moreover, the run-time node 702 includes a tag container 716 that includes a set of tags 718 associated with the run-time node 702. The set of tags 718 may include one or more tags that may have tag types that match tag overlay node-types of one or more run-time tag overlay nodes directly or indirectly associated with the run-time node 702. In an example, a tag type of a tag of the set of tags 718 may be ‘audit tag’. In such an example, the tag type ‘audit tag’ may match an overlay node-type ‘audit overlay node-type’ of the audit overlay node. The set of tags 718 may include tags T8, T9, T10, T11, and T12. Similarly, the run-time node 704 may have a tag container (not shown) including a set of tags associated therewith. The set of tags associated with the run-time node 704 may include tags T13 and T14.

As shown, the tags T8 and T12 are associated with the run-time node 702 by way of the node level association whereas the tags T9, T10, and T11 are associated with the run-time node 702 by way of the node element level association. The tags T13 and T14 are associated with the run-time node 704 by way of the node level association. Notably, based on the run-time node 702 associated with the tags T8, T9, T10, and T11, each of the tags T8, T9, T10, and T11 may be a run-time tag and may include a corresponding tag template and a corresponding tag instance. For example, the tag T8 includes a tag template T8.1 and a tag instance T8.2. The tag template 8.1 may be a pre-defined tag structure and the tag instance T8.2 may be an implementation of the tag template T8.1.

Moreover, the tags T8 and T9 have tag types that match a tag overlay node-type of the run-time tag overlay node 708. Notably, the tag T8 is associated with the run-time node 702 by way of the node level association and the T9 is associated with the run-time node 702 by way of the node element level association by being associated with the attribute A5. Therefore, the tag T8 may be applicable (namely, associated with) on each of the plurality of node elements of the run-time node 702 except for the node element A5. Further, the tags T10 and T11 may be associated with the run-time node 702 by way of the node element level association by being associated with the attributes A6 and A7, respectively. The tags T10 and T11 may have tag types that may match a tag overlay node-type of the run-time tag overlay node 710. Moreover, the tag T12 associated with the run-time node 704 by way of the node level association may have a tag type that may match the tag overlay node-type of the run-time tag overlay node 710. Therefore, the tags T10 and T11 override the tag T12. The tags T10 and T11 may be applicable on attributes A6 and A7, respectively, whereas the tag T12 may be applicable on remaining node elements of the run-time 702. Similarly, the tag T13 of the run-time node 704 may have a tag-type that matches the overlay node-type of the run-time tag overlay node 710, and the tag T14 of the run-time node 704 may have a tag-type that matches the overlay node-type of the run-time tag overlay node 708. The tags T13 and T14 may be associated with the run-time node 704 by way of a node level association and may not be overridden by any other tag of the set of tags associated with the run-time node 704.

The run-time node 704 may be further associated with an overlay node 722 that may have a description and functionalities similar to the overlay node 622.

Various features, embodiments, descriptions, and concepts associated with the tags and tag overlay nodes described in conjunction with the generic nodes 602 and 604 may further be applicable on the tags and tag overlay nodes associated with the run-time nodes 702 and 704. In other words, FIG. 7 may have a description similar to the description of FIG. 6.

In addition, a run-time node (for example, the run-time nodes 702 and 704) may be loaded based on loading of associated node template and node instance. That is to say that the run-time 702 may be loaded based on loading of the node template 702a and the node instance 702b. The node template 702a and the node instance 702b may be loaded as described in conjunction FIG. 5. Similarly, the run-time node (for example, the run-time nodes 702 and 704) may be unloaded based on loading of associated node template and node instance. That is to say that the run-time 702 may be unloaded based on unloading of the node template 702a and the node instance 702b.

Having discussed the tags and tag overlay nodes in association with active nodes that may be generic nodes or run-time nodes. The description now moves towards an implementation of the tags and tag overlay nodes for encrypting associated active nodes. Further, the implementation also sheds light on few additional concepts associated with tags and tag overlay nodes in association with the active nodes in the executable graph-based model 100.

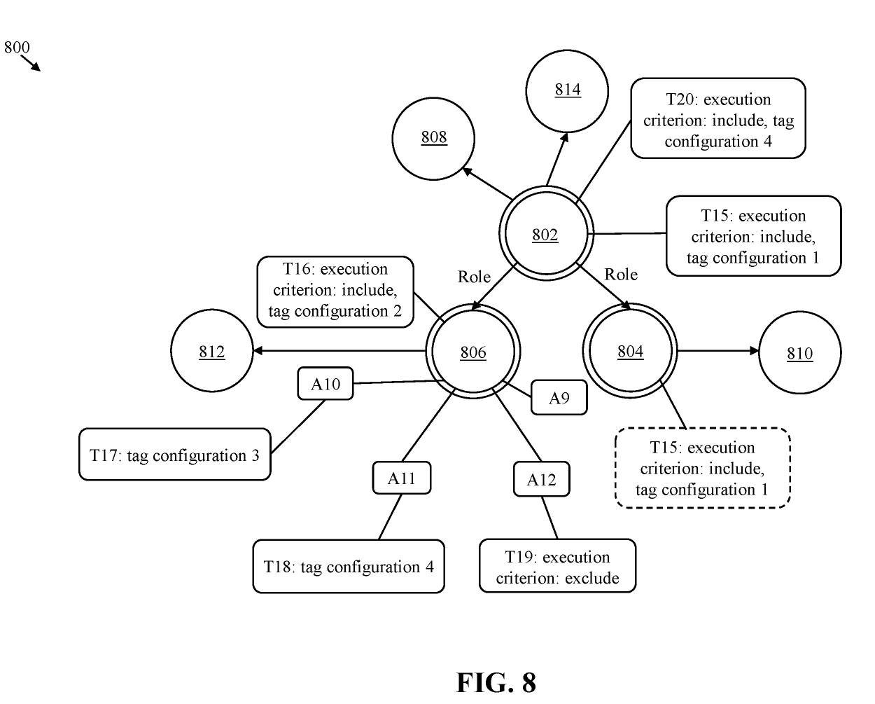

FIG. 8 is a graph 800 that depicts an implementation of tags and tag overlay nodes in association with active nodes in the executable graph-based model 100, consistent with disclosed embodiments of the present disclosure. Referring to FIG. 8, the graph 800 may be an implementation of the executable graph-based model 100. The graph 800 may include a plurality of active nodes 802, 804, and 806. The active nodes 802, 804, and 806 may be generic nodes or run-time nodes. The active node 802 may be an edge node. Additionally, the active nodes 804, and 806 may be edge nodes, vertex nodes, role nodes, or overlay nodes.

In some embodiments, the active nodes 804 and 806 may be vertex nodes coupled by way of the active node 802. The active node 802 may be associated with a tag overlay node i.e., an encryption overlay node 808. The active node 802 may be associated with a tag T15 that may have a tag type that matches a tag overlay node-type of the encryption overlay node 808. The tag T15 may be further indicative of a tag configuration 1 indicative of an operational technique being an encryption algorithm. Further, based on the active node 804 being associated with the active node 802, the processing circuitry (for example, the controller module 206 and the transaction module 208) may determine an absence of a tag with a tag type that matches the tag type of the tag T15 being associated with the active node 804. The processing circuitry (for example, the controller module 206 and the transaction module 208) may associate (as shown by way of a dashed box associated with the active node 804) the tag T15 with the active node 804.

In one embodiment, the tag T15 may be a stateful tag. In such an embodiment, data encrypted using the encryption overlay node 808 may be persistent in the storage element of the overlay system 202 after unloading the tag T15. The tag T15 may be a component of the active node 802. Hence, the tag T15 may be unloaded based on the unloading of the active node 802. The data encrypted by the encryption overlay node 808 in association with the active node 802 may be stored along with a node state of the active node 802. In some embodiments, the data encrypted by the encryption overlay node 808 in association with the active node 802 may be stored in a tag state of the tag T15 included within the node state of the active node 802.

Based on the tag T15 being the stateful node, the processing circuitry (for example, the controller module 206 or the transaction module 208) may be configured to create a clone (depicted by way of a dashed box associated with the active node 804) of the tag T15 and associate the cloned tag T15 with the active node 804. The cloned tag T15 may be a component of the active node 804. Hence, the cloned tag T15 (depicted by way of the dashed box associated with the active node 804) may be unloaded based on unloading of the active node 804. Further, the active node 804 may be associated with an encryption overlay node 810 having a tag overlay node-type that matches the tag type of the tag T15/ the cloned tag T15. Data encrypted by the encryption overlay node 810 in association with the active node 804 may be stored along with a node state of the active node 804. In some embodiments, the data encrypted by the encryption overlay node 810 in association with the active node 804 may be stored in a tag state of the cloned tag T15 included within the node state of the active node 804.

Notably, a tag configuration and/or an execution criterion of a cloned tag (for example, the clone tag T15) may be same as its original tag (for example, the tag T15). Additionally, the tag configuration and/or the execution criterion of the cloned tag (for example, the cloned tag T15) may not be modified. Additionally, an output of an execution of the encryption overlay node 810 on the active node 804 may be stored in association with the cloned tag T15.

In another embodiment, the tag T15 may be a stateless tag. In such an embodiment, data encrypted using the encryption overlay node 808 may not be persistent in the storage element of the overlay system 202 after unloading the tag T15. The tag T15 may be a component of the active node 802. Hence, the tag T15 may be unloaded based on unloading of the active node 802. The data encrypted by the encryption overlay node 808 in association with the active node 802 may cease to exist based on the unloading of the tag T15.

Based on the tag T15 being the stateless node, the processing circuitry (for example, the controller module 206 or the transaction module 208) may be configured to integrate a reference (for example, a storage location, a pointer, a link, or the like) of the tag T15 in the active node 804. The tag T15 may be applicable on the active node 804 based on the reference.

In some embodiments, the active node 806 may be associated with an encryption overlay node 812. Further, the active node 806 may be associated with a tag T16 having a tag type that matches the tag type of the tag T15. The tag T16 may include an execution criterion ‘include’ and a tag configuration 2 indicative of an operation criterion being an encryption technique. The tag configuration 2 may be different from the tag configuration 1. Therefore, the tag T16 overrides the tag T15. Hence, the tag T15 may not be applicable on the active node 806 instead the tag T16 may be applicable on the active node 806. Therefore, processing logic associated with the encryption overlay node 812 may be executed on the active node 806 based on the tag T16.

The active node 806 may include a plurality of node elements including attributes A9, A10, A11, and A12. The attribute A9 may not be associated with a tag having a tag type that matches a tag overlay node-type of the encryption overlay node 812. Therefore, the processing circuitry (for example, the controller module 206 and the transaction module 208) may be configured to determine an absence of a tag having a tag type that matches the tag type of the tag T16 being associated with the attribute A9. Based on such a determination, processing circuitry (for example, the controller module 206 and the transaction module 208) may be configured to associate the tag T16 with the attribute A9. Subsequently, the processing logic associated with the encryption overlay node 812 may be executed on the attribute A9 based on the tag T16.

In some embodiments, the tag T16 may be a stateful tag. In such an embodiment, the processing circuitry (for example, the controller module 206 and the transaction module 208) may be configured to associate a clone of the tag T16 with the attribute A9 in a manner similar to the association of the tag T15 with the active node 804 based on the tag T15 being the stateful tag.

In some embodiments, the tag T16 may be a stateless tag. In such an embodiment, the processing circuitry (for example, the controller module 206 and the transaction module 208) may be configured to associate the tag T16 with the attribute A9 by integrating a reference (for example, a pointer, a storage location, a link, or the like) of the tag T16 in the attribute A9 in a manner similar to association of the tag T15 with the active node 804 based on the tag T15 being the stateless tag.

Further, the attribute A10 may be associated with a tag T17 having a tag type that matches the tag overlay node-type of the encryption overlay node 812. The tag T17 may include a tag configuration 3 indicative of an operation criterion being an encryption technique. The tag configuration 3 may be different from the tag configurations 1 and 2. The processing logic associated with the encryption overlay node 812 may be executed on the attribute A10 based on the tag configuration 3 included in the tag T17. Similarly, the attribute A11 may be associated with a tag T18 having a tag type that matches the tag overlay node-type of the encryption overlay node 812. The tag T18 may include a tag configuration 4. The tag configuration 4 may be different from the tag configurations 1, 2, and 3. Therefore, the processing logic associated with the encryption overlay node 812 may be executed on the attribute A11 based on the tag configuration 4 included in the tag T18. Moreover, the attribute A12 may be associated with a tag T19 having a tag type that matches the tag overlay node-type of the encryption overlay node 812. The tag T19 may include an execution criterion ‘exclude’ which may be indicative of the encryption overlay node 812 being inapplicable on the attribute A12. Hence, the processing logic associated with the encryption overlay node 812 may not be applicable to the attribute A12.

In some embodiments, an active node may be associated with a first tag having a first tag type by way of the node level association. The first tag is indicative of a first execution criterion and a first tag configuration. Further, the active node may be associated with a second tag by way of a node element level association. The second tag may also have the first tag type and may be indicative of a second execution criterion. The second execution criterion may be a negation of the first execution criterion. Alternatively, the second tag may have a second tag configuration which may override the first tag configuration. Based on an absence of an execution criterion that negates the first execution criterion, the first execution criterion may be associated with the second tag. Further, the active node may be associated with a tag overlay node having a tag overlay node-type that matches the first tag type. Processing logic of the tag overlay node may be executed on each node element of the active node, except for a node element, of the active node, associated with the second tag, based on the first tag configuration. The processing logic of the tag overlay node may be executed on the node element associated with the second tag based on the second tag configuration.

In some embodiments, the graph 800, being the implementation of the executable graph-based model 100, may be a hierarchical structure. In such an embodiment, the active node 802 may be a parent node of the active nodes 804 and 806. As shown, the active node 802 may be associated with a tag overlay node ‘obfuscation overlay node 814’. The active node 802 may be further associated with a tag T20 having a tag type that matches a tag overlay node-type of the obfuscation overlay node 814. The tag T20 may be indicative of an execution criterion ‘include’ and may further have a tag configuration 4 indicative of a character length that may be obfuscated based on execution of processing logic associated with an obfuscation overlay node that is executed based on the tag T20. The tag configuration 4 may be further indicative of a string of symbols, alphanumeric characters, or the like that may be used to obfuscate data based on the tag T20. The tag configuration 4 may also include an end (left end/right end) of a data string from which the obfuscation may have to be initiated.

The active nodes 804 and 806 may not be associated with tags with a tag type that matches a tag overlay node-type of the obfuscation overlay node 814. However, the active nodes 804 and 806 may be associated with a tag overlay node (not shown) that may have the tag overlay node-type that matches the tag overlay node-type of the obfuscation overlay node 814. Therefore, the processing circuitry (for example, the controller module 206 and the transaction module 208, or the like) may be configured to associate the tag T20 with the active nodes 804 and 806. Hence, processing logic associated with tag overlay nodes having the tag overlay node-type that matches the tag overlay node-type of the obfuscation overlay node 814 may be executed on the active nodes 804 and 806 based on the tag T20.

Notably, the processing circuitry (for example, the controller module 206 and the transaction module 208) may be configured to determine absence of tags in association with active nodes and node elements. Based on the determined absence, the processing circuitry (for example, the controller module 206 and the transaction module 208) may be further configured to associate a relevant tag with the active nodes and node elements. Subsequently, an operation to process a stimulus may be performed based on determination of the active node as well as one or more other active nodes or node elements that may be determined based on association with the active node.

It will be apparent to a person skilled in the art that various tag types and tag overlay nodes described throughout the description are non-limiting and do not limit the scope of the disclosure. In practical implementations, any number and any type of tags and tag overlay nodes may be instantiated using the executable graph-based models 100 without deviating from the scope of the disclosure.

Having discussed an exemplary implementation of the overlay system 202 disclosed herein, the description now moves towards a computing system that may be used for such implementations of the executable graph-based model 100.

FIG. 9 shows an example computing system 900 for carrying out the methods of the present disclosure, consistent with disclosed embodiments of the present disclosure. Specifically, FIG. 9 shows a block diagram of an embodiment of the computing system 900 according to example embodiments of the present disclosure.

The computing system 900 may be configured to perform any of the operations disclosed herein, such as for example, any of the operations discussed with reference to the functional modules described in relation to FIG. 2. The computing system 900 can be implemented as a conventional computer system, an embedded controller, a laptop, a server, a mobile device, a smartphone, a set-top box, a kiosk, a vehicular information system, one or more processors associated with a television, a customized machine, any other hardware platform, or any combination or multiplicity thereof. In one embodiment, the computing system 900 is a distributed system configured to function using multiple computing machines interconnected via a data network or bus system.

The computing system 900 includes computing devices (such as a computing device 902). The computing device 902 includes one or more processors (such as a processor 904) and a memory 906. The processor 904 may be any general-purpose processor(s) configured to execute a set of instructions. For example, the processor 904 may be a processor core, a multiprocessor, a reconfigurable processor, a microcontroller, a digital signal processor (DSP), an application-specific integrated circuit (ASIC), a graphics processing unit (GPU), a neural processing unit (NPU), an accelerated processing unit (APU), a brain processing unit (BPU), a data processing unit (DPU), a holographic processing unit (HPU), an intelligent processing unit (IPU), a microprocessor/microcontroller unit (MPU/MCU), a radio processing unit (RPU), a tensor processing unit (TPU), a vector processing unit (VPU), a wearable processing unit (WPU), a field programmable gate array (FPGA), a programmable logic device (PLD), a controller, a state machine, gated logic, discrete hardware component, any other processing unit, or any combination or multiplicity thereof. In one embodiment, the processor 904 may be multiple processing units, a single processing core, multiple processing cores, special purpose processing cores, co-processors, or any combination thereof. The processor 904 may be communicatively coupled to the memory 906 via an address bus 908, a control bus 910, a data bus 912, and a messaging bus 914.

The memory 906 may include non-volatile memories such as a read-only memory (ROM), a programable read-only memory (PROM), an erasable programmable read-only memory (EPROM), a flash memory, or any other device capable of storing program instructions or data with or without applied power. The memory 906 may also include volatile memories, such as a random-access memory (RAM), a static random-access memory (SRAM), a dynamic random-access memory (DRAM), and a synchronous dynamic random-access memory (SDRAM). The memory 906 may include single or multiple memory modules. While the memory 906 is depicted as part of the computing device 902, a person skilled in the art will recognize that the memory 906 can be separate from the computing device 902.

The memory 906 may store information that can be accessed by the processor 904. For instance, the memory 906 (e.g., one or more non-transitory computer-readable storage mediums, memory devices) may include computer-readable instructions (not shown) that can be executed by the processor 904. The computer-readable instructions may be software written in any suitable programming language or may be implemented in hardware. Additionally, or alternatively, the computer-readable instructions may be executed in logically and/or virtually separate threads on the processor 904. For example, the memory 906 may store instructions (not shown) that when executed by the processor 904 cause the processor 904 to perform operations such as any of the operations and functions for which the computing system 900 is configured, as described herein. Additionally, or alternatively, the memory 906 may store data (not shown) that can be obtained, received, accessed, written, manipulated, created, and/or stored. The data can include, for instance, the data and/or information described herein in relation to FIGS. 1-8. In some implementations, the computing device 902 may obtain from and/or store data in one or more memory device(s) that are remote from the computing system 900.

The computing device 902 may further include an input/output (I/O) interface 916 communicatively coupled to the address bus 908, the control bus 910, and the data bus 912. The data bus 912 and messaging bus 914 may include a plurality of tunnels that may support parallel execution of messages by the overlay system 202. The I/O interface 916 is configured to couple to one or more external devices (e.g., to receive and send data from/to one or more external devices). Such external devices, along with the various internal devices, may also be known as peripheral devices. The I/O interface 916 may include both electrical and physical connections for operably coupling the various peripheral devices to the computing device 902. The I/O interface 916 may be configured to communicate data, addresses, and control signals between the peripheral devices and the computing device 902. The I/O interface 916 may be configured to implement any standard interface, such as a small computer system interface (SCSI), a serial-attached SCSI (SAS), a fiber channel, a peripheral component interconnect (PCI), a PCI express (PCIe), a serial bus, a parallel bus, an advanced technology attachment (ATA), a serial ATA (SATA), a universal serial bus (USB), Thunderbolt, FireWire, various video buses, or the like. The I/O interface 916 is configured to implement only one interface or bus technology. Alternatively, the I/O interface 916 is configured to implement multiple interfaces or bus technologies. The I/O interface 916 may include one or more buffers for buffering transmissions between one or more external devices, internal devices, the computing device 902, or the processor 904. The I/O interface 916 may couple the computing device 902 to various input devices, including mice, touch screens, scanners, biometric readers, electronic digitizers, sensors, receivers, touchpads, trackballs, cameras, microphones, keyboards, any other pointing devices, or any combinations thereof. The I/O interface 916 may couple the computing device 902 to various output devices, including video displays, speakers, printers, projectors, tactile feedback devices, automation control, robotic components, actuators, motors, fans, solenoids, valves, pumps, transmitters, signal emitters, lights, and so forth.

The computing system 900 may further include a storage unit 918, a network interface 920, an input controller 922, and an output controller 924. The storage unit 918, the network interface 920, the input controller 922, and the output controller 924 are communicatively coupled to the central control unit (e.g., the memory 906, the address bus 908, the control bus 910, and the data bus 912) via the I/O interface 916. The network interface 920 communicatively couples the computing system 900 to one or more networks such as wide area networks (WAN), local area networks (LAN), intranets, the Internet, wireless access networks, wired networks, mobile networks, telephone networks, optical networks, or combinations thereof. The network interface 920 may facilitate communication with packet-switched networks or circuit-switched networks which use any topology and may use any communication protocol. Communication links within the network may involve various digital or analog communication media such as fiber optic cables, free-space optics, waveguides, electrical conductors, wireless links, antennas, radio-frequency communications, and so forth.

The storage unit 918 is a computer-readable medium, preferably a non-transitory computer-readable medium, comprising one or more programs, the one or more programs comprising instructions which when executed by the processor 904 cause the computing system 900 to perform the method steps of the present disclosure. Alternatively, the storage unit 918 is a transitory computer-readable medium. The storage unit 918 can include a hard disk, a floppy disk, a compact disc read-only memory (CD-ROM), a digital versatile disc (DVD), a Blu-ray disc, a magnetic tape, a flash memory, another non-volatile memory device, a solid-state drive (SSD), any magnetic storage device, any optical storage device, any electrical storage device, any semiconductor storage device, any physical-based storage device, any other data storage device, or any combination or multiplicity thereof. In one embodiment, the storage unit 918 stores one or more operating systems, application programs, program modules, data, or any other information. The storage unit 918 is part of the computing device 902. Alternatively, the storage unit 918 is part of one or more other computing machines that are in communication with the computing device 902, such as servers, database servers, cloud storage, network attached storage, and so forth.

The input controller 922 may include suitable logic, circuitry, interfaces, and/or code, executable by the circuitry, that may be configured to control one or more input devices that may be configured to receive an input (the stimulus 230) for the overlay system 202. The output controller 924 may include suitable logic, circuitry, interfaces, and/or code, executable by the circuitry, that may be configured to control one or more output devices that may be configured to render/output the outcome of the operation executed to process the received input (the stimulus 230).

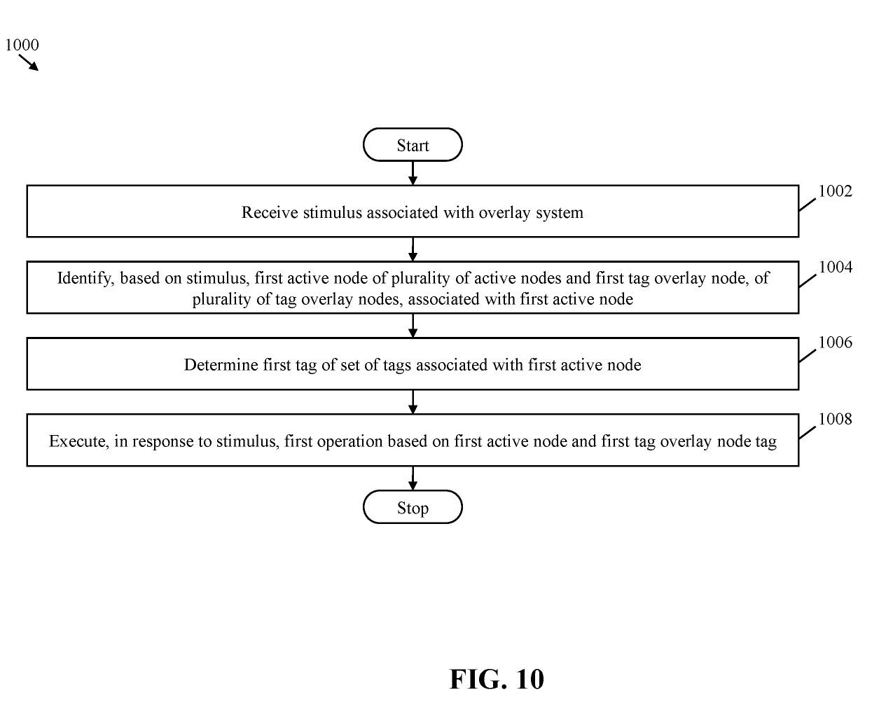

FIG. 10 is a flowchart 1000 of a method for implementing tags and tag overlay nodes in association with active nodes in the executable graph-based model, consistent with disclosed embodiments of the present disclosure. Referring to FIG. 10, at 1002, a stimulus (for example, the stimulus 230) associated with the overlay system 202 is received. The processing circuitry (such as the controller module 206 and the stimuli management module 212) may receive the stimulus associated with the overlay system 202.

At 1004, based on the stimulus, a first active node of the plurality of active nodes and a first tag overlay node of a plurality of tag overlay nodes, of the executable graph-based model 100 may be identified. The processing circuitry ((such as such as the controller module 206, the transaction module 208, and the stimuli management module 212) may be configured to identify the first active node and the first tag overlay node based on the stimulus.

At 1006, a first tag of a set of tags associated with the first active node may be determined. The first tag may have a first tag type that matches a tag overlay node-type of the first tag overlay node. The processing circuitry (such as the controller module 206, the transaction module 208, and the stimuli management module 212) may be configured to retrieve the set of tags associated with the first active node. The processing circuitry (such as the controller module 206, the transaction module 208, and the stimuli management module 212) may be further configured to compare the tag overlay node-type of the first tag overlay node with tag type of each tag of the set of tags to determine the first tag. The first tag is determined based on the first tag type being a match to the first tag overlay node-type.

At 1008, a first operation may be executed, in response to the stimulus. The first operation may be executed based on the first active node and the first tag overlay node. The execution of the first operation may conform with an execution criterion indicated by the first tag. The execution of the first operation may further conform with a tag configuration indicated by the first tag. The tag configuration may be indicative of an operational technique being an algorithm, model, or the like to be used for execution of processing logic associated with the first tag overlay node. The processing circuitry (such as the controller module 206, the transaction module 208, or the like) may be configured to execute the first operation, based on the first active node and the first tag overlay node, in response to the stimulus.

The disclosed embodiments encompass numerous advantages including a simple and user-friendly implementation of the executable graph-based model 100 that may be in turn used to implement tags and tag overlay nodes by way of the overlay system 202. The disclosed systems and methods allow for a streamlined architecture of the overlay system 202 that enables efficient, selective execution of processing logic on specific parts of an active node's logical structure. The implementation of tags at the node level and the node element level allows for isolation of various component of the active node’s logical structure for execution of a tag overlay node associated with the active node. By integrating tags at the node level and the node element level, the disclosed overlay system 202 ensures reliable identification and interaction with desired portions of the active node while minimizing computational overhead and reducing the risk of unintended side effects. Also, implementation of tags at the node element level allows for changes in the active node without having to modify processing logic of the associated tag overlay node. The disclosed overlay system 202 significantly enhances reusability, scalability, and performance, making it ideal for resource-constrained environments and applications with strict performance requirements. Furthermore, simplified architecture of the overlay system 202 is based on the implementation the tags and tag overlay nodes which significantly reduces development timelines, operational costs, and maintenance complexity, enabling systems to adapt quickly to evolving demands while maintaining robustness and efficiency.

In addition, the implementation of the tags in the executable graph-based model 100 may significantly benefit the overlay system 202 by enhancing its organization, searchability, and overall usability. A non-exhaustive list of advantages associated with the implementation of tags and tag overlay nodes in the overlay system is provided below:
(i) Enhanced Categorization: Implementation of the tags in the executable graph-based model 100 provides a flexible and dynamic way to categorize the active nodes within the executable graph-based model 100. By assigning relevant tags to various active nodes and node elements, relevant categories may be created to organize and structure the data and/or processing logic associated with the overlay system 202.
(ii) Facilitates Search and Retrieval: Implementation of the tags in the executable graph-based model 100 allows the users of the overlay system 202 to easily search and retrieve specific active nodes or relationships within the executable graph-based model 100. The users may use tags as keywords to locate and filter relevant information in a significantly reduced period of time.
(iii) Flexible Taxonomy: Implementation of the tags in the executable graph-based model 100 provides for a flexible approach to creating taxonomies compared to predefined hierarchical structures. The users may assign multiple tags to a single active node, allowing for a significantly nuanced and context-specific categorization of the plurality of active nodes.
(iv) Dynamic Updates: Implementation of the tags in the executable graph-based model 100 allows the overlay system 202 to adapt to changing requirements in a seamless manner. As new concepts or categories emerge, the users may apply relevant tags without having to modify an underlying structure of the executable graph-based model 100.
(v) Improved Collaboration: Implementation of the tags in the executable graph-based model 100 facilitates collaboration by providing a shared and consistent way to label and organize graph elements. Team members can use a standardized set of tags to ensure a common understanding of the data.
(vi) Personalization and Customization: Implementation of the tags in the executable graph-based model 100 allows the users of the overlay system 202 to personalize their user experience by adding custom tags to one or more active nodes or relationships based on their specific needs or preferences. This enables a more tailored and user-friendly interaction with the overlay system 202.
(vii) Contextual Insights: Implementation of the tags in the executable graph-based model 100 allows appending of contextual information to the active nodes. This may assist the users to understand a significance or purpose of specific elements within the executable graph-based model 100. Hence, the implementation of the tags in the executable graph-based model 100 allows for significant ease in interpretation and insight derivation from the data and/or processing logic associated with the overlay system 202.
(viii) Graph Exploration and Visualization: Implementation of the tags in the executable graph-based model 100 allows for effective exploration and visualization of the executable graph-based model 100. The users of the overlay system 202 may filter and highlight nodes with specific tags, allowing for a focused and efficient analysis of relevant portions of the executable graph-based model 100.
(ix) Integration with External Systems: The tags in the executable graph-based model 100 may serve as a bridge between the executable graph-based model 100 and external systems or metadata associated with the plurality of active nodes. This integration allows for consistency in labeling and provides a common language for connecting graph data with other information sources.
(x) Temporal Tagging: The tags may be assigned with timestamps, allowing for temporal categorization. This is particularly useful when tracking changes or events related to specific active nodes or node elements over time.
(xi) Semantic Enrichment: The tags may further contribute to semantic enrichment of the executable graph-based model 100 by adding descriptive labels, making the executable graph-based model 100 more interpretable and meaningful to the users.
(xii) User-Defined Taxonomies: The users may create customized taxonomies by assigning tags based on their unique perspectives and requirements. This flexibility accommodates diverse use cases and user preferences.

The implementation of tags in the executable graph-based model 100 provides a versatile and user-friendly approach for organizing and navigating the data and/or processing logic associated with the overlay system 202. Further, the implementation of tags in the executable graph-based model 100 allows for a significant increase in flexibility and adaptability of the overlay system 202. Additionally, the implementation of tags in the executable graph-based model 100 allows for a significant improvement in collaborations using the overlay system 202. This makes the executable graph-based model 100 seamlessly accessible and useful to users with varying needs.

A person of ordinary skill in the art will appreciate that embodiments and exemplary scenarios of the disclosed subject matter may be practiced with various computer system configurations, including multi-core multiprocessor systems, minicomputers, mainframe computers, computers linked or clustered with distributed functions, as well as pervasive or miniature computers that may be embedded into virtually any device. Further, the operations may be described as a sequential process, however, some of the operations may be performed in parallel, concurrently, and/or in a distributed environment, and with program code stored locally or remotely for access by single or multiprocessor machines. In addition, in some embodiments, the order of operations may be rearranged without departing from the spirit of the disclosed subject matter.

Techniques consistent with the present disclosure provide, among other features, systems and methods for facilitating implementation of tags and tag overlay nodes in the executable graph-based models. While various embodiments of the disclosed systems and methods have been described above, it should be understood that they have been presented for purposes of example only, and not limitations. It is not exhaustive and does not limit the present disclosure to the precise form disclosed. Modifications and variations are possible in light of the above teachings or may be acquired from practicing the present disclosure, without departing from the breadth or scope.

Moreover, for example, the present technology/system may achieve the following configurations:

1. An overlay system, comprising:

a storage element configured to store an executable graph-based model that includes a plurality of active nodes associated with a plurality of tag overlay nodes, wherein each active node, of the plurality of active nodes, has a set of tags associated therewith, with each tag of the set of tags indicating an execution criterion for a tag overlay node of the plurality of tag overlay nodes, and

processing circuitry that is coupled to the storage element, and configured to:

receive a first stimulus associated with the overlay system;

identify, based on the first stimulus, a first active node of the plurality of active nodes;

determine, a first tag overlay node-type of a first tag overlay node, of the plurality of tag overlay nodes, associated with the first active node;

determine a first tag of a first set of tags associated with the first active node, wherein the first tag has a first tag type that matches the first tag overlay node-type of the first tag overlay node; and

execute, in response to the first stimulus, a first operation based on the first active node and the first tag overlay node, wherein the execution of the first operation conforms with a first execution criterion indicated by the first tag.

2. The overlay system of 1,

wherein the first operation is executed further based on a tag configuration associated with the first tag, and

wherein the tag configuration is indicative of an operational technique associated with the first tag overlay node.

3. The overlay system of 1, wherein the first tag overlay node-type of the first tag overlay node is determined based on the first operation conforming to processing logic associated with the first tag overlay node.

4. The overlay system of 1, based on the identification of the first active node and the determination of the first tag overlay node-type of the first tag overlay node, the processing circuitry is further configured to:

retrieve the first set of tags associated with the first active node, and

compare the first tag overlay node-type of the first tag overlay node with a tag type of each tag of the first set of tags to determine the first tag, wherein the first tag is determined based on the first tag type being a match to the first tag overlay node-type.

5. The overlay system of 1, wherein the association of each tag of the first set of tags with the first active node is at least one of a group consisting of (i) a node level association or (ii) a node element level association.

6. The overlay system of 1,

wherein the first tag overlay node includes an implementation logic that corresponds to a pre-execution task associated with the first tag overlay node, and

wherein to determine the first tag, the processing circuitry is further configured to:

execute the implementation logic of the first tag overlay node; and

compare, based on the execution of the implementation logic, the first tag overlay node-type of the first tag overlay node with a tag type of each tag of the first set of tags to determine the first tag having the first tag type that matches the first tag overlay node-type.

7. The overlay system of 1, wherein the first active node is further associated with a tag container that stores the first set of tags.

8. The overlay system of 1,

wherein the first active node includes a plurality of node elements, and the first tag is associated with one or more node elements of the plurality of node elements, and

wherein the first operation is executed further based on the one or more node elements.

9. The overlay system of 1, wherein the first tag is one of a group consisting of a stateful tag or a stateless tag.

10. The overlay system of 9, wherein based on the first tag being the stateful tag, an output of the first operation persists in the storage element upon an unloading of the first tag from the executable graph-based model.

11. The overlay system of 9, wherein based on the first tag being the stateless tag, an output of the first operation ceases to persist in the storage element upon an unloading of the first tag from the executable graph-based model.

12. The overlay system of 1,

wherein the association of the first tag with the first active node is a node level association,

wherein the first active node further has a node element level association with a second tag of the first set of tags,

wherein the second tag is associated with a first node element of a plurality of node elements of the first active node,

wherein the second tag has the first tag type and is indicative of a second execution criterion, and

wherein the first operation is executed further based on the first node element and in conformity with the second execution criterion.

13. The overlay system of 1, wherein the first tag inherits from a third tag of the first set of tags.

14. The overlay system of 1, wherein the first tag inherits from a fourth tag associated with a second active node of the plurality of active nodes.

15. The overlay system of 14, wherein based on a loading of the first active node in the executable graph-based model, the processing circuitry is further configured to load the second active node in the executable graph-based model.

16. The overlay system of 1,

wherein the association of the first tag with the first active node is a node level association,

wherein the first active node includes a plurality of node elements,

wherein a second node element of the plurality of node elements has an absence of an associated tag with the first tag type,

wherein, based on the absence of the tag with the first tag type being associated with the second node element, the processing circuitry is configured to associate the first tag with the second node element, and

wherein the first operation is executed further based on the second node element.

17. The overlay system of 16, wherein based on the first tag being a stateful tag, the processing circuitry is further configured to create a clone of the first tag and associate the clone of the first tag with the second node element.

18. The overlay system of 16, wherein based on the first tag being a stateless tag, the processing circuitry is further configured to integrate a reference to the first tag in the second node element.

19. The overlay system of 1, wherein prior to the execution of the first operation, the processing circuitry is further configured to:

determine whether at least one of a group consisting of the first active node or the first tag overlay node is loaded in the executable graph-based model;

load, based on at least one of the group consisting of the first active node or the first tag overlay node being unloaded from the executable graph-based model, at least one of the group consisting of the first active node or the first tag overlay node in the executable graph-based model; and

load, based on the loading of the first active node, the first tag, in the executable graph-based model, in association with the first active node.

20. The overlay system of 1, wherein based on the first active node being unloaded from the executable graph-based model, the processing circuitry is further configured to unload the first tag in association with the first active node.

21. The overlay system of 1, wherein the first active node is one of a group consisting of an edge node, a vertex node, a role node, or an overlay node.

22. The overlay system of 1, wherein based on the first active node being an edge node, the first active node is associated with a third active node and a fourth active node with the first active node coupling the third active node and the fourth active node.

23. The overlay system of 22,

wherein, based on an absence of a tag with the first tag type being associated with at least one of a group consisting of the third active node or the fourth active node, the processing circuitry is configured to associate the first tag to at least one of the group consisting of the third active node or the fourth active node with the absence of the tag with the first tag type, and

wherein the first operation is executed further based on at least one of the group consisting of the third active node or the fourth active node, associated with the first tag.

24. The overlay system of 1, wherein the first tag overlay node includes a processing logic that corresponds to a functionality of the first tag overlay node.

25. The overlay system of 1, wherein the processing circuitry is further configured to:

receive a second stimulus associated with the overlay system;

identify, based on the second stimulus, the first active node of the plurality of active nodes;

determine, a second tag overlay node-type of a second tag overlay node, of the plurality of tag overlay nodes, associated with the first active node;

determine a fifth tag of the first set of tags, wherein the fifth tag has a second tag type that matches the second tag overlay node-type of the second tag overlay node; and

execute, in response to the second stimulus, a second operation based on the first active node and the second tag overlay node, wherein the execution of the second operation conforms with a second execution criterion indicated by the fifth tag.

26. The overlay system of 1, wherein the processing circuitry is further configured to:

receive a third stimulus associated with the overlay system;

identify, based on the third stimulus, a fifth active node of the plurality of active nodes;

determine, the first tag overlay node-type of the first tag overlay node associated with the fifth active node;

determine a sixth tag of a second set of tags associated with the fifth active node, wherein the sixth tag has the first tag type; and

execute, in response to the third stimulus, a third operation based on the fifth active node and the first tag overlay node, wherein the execution of the third operation conforms with a third execution criterion indicated by the sixth tag.

27. The overlay system of 1,

wherein the executable graph-based model is a hierarchical structure,

wherein the first active node is a parent node of a sixth active node of the plurality of active nodes, and

wherein the processing circuitry is further configured to:

determine an absence of a tag with the first tag type being associated with the sixth active node; and

associate, based on the absence of the tag with the first tag type being associated with the sixth active node, the first tag with the sixth active node, wherein the first operation is executed further based on the sixth active node.

28. The overlay system of 1,

wherein the executable graph-based model further includes a plurality of generic overlay nodes, and

wherein the first tag overlay node is further configured to inherit from one or more generic overlay nodes of the plurality of generic overlay nodes.

29. The overlay system of 1, wherein the first tag overlay node is further configured to inherit from one or more tag overlay nodes of the plurality of tag overlay nodes.

30. The overlay system of 1, wherein the first active node further includes a first overlay manager configured to manage the association of the first active node with the first tag overlay node.

31. The overlay system of 1,

wherein the executable graph-based model further includes a plurality of generic overlay nodes,

wherein the first tag overlay node is associated with at least one of a group consisting of (i) a first generic overlay node of the plurality of generic overlay nodes or (ii) a third tag overlay node of the plurality of tag overlay nodes with at least one of the group consisting of (i) the first generic overlay node or (ii) the third tag overlay node extending a functionality of the first tag overlay node, and

wherein the first operation is executed further based on at least one of the group consisting of (i) the first generic overlay node or (ii) the third tag overlay node.

32. The overlay system of 31, wherein the first tag overlay node further includes a second overlay manager configured to manage the association of the first tag overlay node with at least one of the group consisting of (i) the first generic overlay node or (ii) the third tag overlay node.

33. The overlay system of 1, wherein the first active node is a generic node, and the first tag is a generic tag.

34. The overlay system of 1,

wherein the first active node is a run-time node including (i) a node template that corresponds to a predefined node structure, and (ii) a node instance that corresponds to an implementation of the node template, and

wherein the first tag corresponds to a run-time tag including (i) a tag template that corresponds to a predefined tag structure, and (ii) a tag instance that corresponds to an implementation of the tag template.

35. The overlay system of 34,

wherein the processing circuitry is further configured to load the first active node based on a loading of the node template and the node instance, and

wherein, based on the loading of the first active node, the processing circuitry is further configured to load the first tag based on a loading of the tag template and the tag instance of the first tag.

36. A method, comprising:

receiving, by processing circuitry, a stimulus associated with an overlay system,

wherein an executable graph-based model is stored in a storage element of the overlay system,

wherein the executable graph-based model includes a plurality of active nodes associated with a plurality of tag overlay nodes, and

wherein each active node, of the plurality of active nodes, has a set of tags associated therewith, with each tag of the set of tags indicating an execution criterion for a tag overlay node of the plurality of tag overlay nodes;

identifying, by the processing circuitry, based on the stimulus, a first active node of the plurality of active nodes;

determining, by the processing circuitry, a first tag overlay node-type of a first tag overlay node, of the plurality of tag overlay nodes, associated with the first active node;

determining, by the processing circuitry, a first tag of a first set of tags associated with the first active node, wherein the first tag has a first tag type that matches the first tag overlay node-type of the first tag overlay node; and

executing, by the processing circuitry, in response to the first stimulus, a first operation based on the first active node and the first tag overlay node, wherein the execution of the first operation conforms with a first execution criterion indicated by the first tag.

What is claimed is:

1. An overlay system, comprising:
a storage element configured to store an executable graph-based model that includes a plurality of active nodes associated with a plurality of tag overlay nodes, wherein each active node, of the plurality of active nodes, has a set of tags associated therewith, with each tag of the set of tags indicating an execution criterion for a tag overlay node of the plurality of tag overlay nodes; and
processing circuitry that is coupled to the storage element, and configured to:
receive a first stimulus associated with the overlay system;
identify, based on the first stimulus, a first active node of the plurality of active nodes;
determine, a first tag overlay node-type of a first tag overlay node, of the plurality of tag overlay nodes, associated with the first active node;
determine a first tag of a first set of tags associated with the first active node, wherein the first tag has a first tag type that matches the first tag overlay node-type of the first tag overlay node; and
execute, in response to the first stimulus, a first operation based on the first active node and the first tag overlay node, wherein the execution of the first operation conforms with a first execution criterion indicated by the first tag.

2. The overlay system of claim 1,
wherein the first operation is executed further based on a tag configuration associated with the first tag, and
wherein the tag configuration is indicative of an operational technique associated with the first tag overlay node.

3. The overlay system of claim 1, wherein based on the identification of the first active node and the determination of the first tag overlay node-type, the processing circuitry is further configured to:
retrieve the first set of tags associated with the first active node, and
compare the first tag overlay node-type of the first tag overlay node with a tag type of each tag of the first set of tags to determine the first tag, wherein the first tag is determined based on the first tag type being a match to the first tag overlay node-type.

4. The overlay system of claim 1, wherein the association of each tag of the first set of tags with the first active node is at least one of a group consisting of (i) a node level association or (ii) a node element level association.

5. The overlay system of claim 1,
wherein the first tag overlay node includes an implementation logic that corresponds to a pre-execution task associated with the first tag overlay node, and
wherein, to determine the first tag, the processing circuitry is further configured to:
execute the implementation logic of the first tag overlay node; and
compare, based on the execution of the implementation logic, the first tag overlay node-type of the first tag overlay node with a tag type of each tag of the first set of tags to determine the first tag having the first tag type that matches the first tag overlay node-type.

6. The overlay system of claim 1,
wherein the first active node includes a plurality of node elements, and the first tag is associated with one or more node elements of the plurality of node elements, and
wherein the first operation is executed further based on the one or more node elements.

7. The overlay system of claim 1,
wherein the first tag is one of a group consisting of a stateful tag or a stateless tag,
wherein based on the first tag being the stateful tag, an output of the first operation persists in the storage element upon an unloading of the first tag from the executable graph-based model, and
wherein based on the first tag being the stateless tag, the output of the first operation ceases to persist in the storage element upon an unloading of the first tag from the executable graph-based model.

8. The overlay system of claim 1,
wherein the association of the first tag with the first active node is a node level association,
wherein the first active node further has a node element level association with a second tag of the first set of tags,
wherein the second tag is associated with a first node element of a plurality of node elements of the first active node,
wherein the second tag has the first tag type and is indicative of a second execution criterion, and
wherein the first operation is executed further based on the first node element and in conformity with the second execution criterion.

9. The overlay system of claim 1, wherein the first tag inherits from at least one of a group consisting of (i) a third tag of the first set of tags or (ii) a fourth tag associated with a second active node of the plurality of active nodes.

10. The overlay system of claim 1,
wherein the association of the first tag with the first active node is a node level association,
wherein the first active node includes a plurality of node elements,
wherein a second node element of the plurality of node elements has an absence of an associated tag with the first tag type,
wherein, based on the absence of the associated tag with the first tag type with the second node element, the processing circuitry is configured to associate the first tag with the second node element, and
wherein the first operation is executed further based on the second node element.

11. The overlay system of claim 10,
wherein the first tag is at least one of a group consisting of a stateful tag or a stateless tag,
wherein based on the first tag being the stateful tag, the processing circuitry is further configured to create a clone of the first tag and associate the clone of the first tag with the second node element, and
wherein based on the first tag being the stateless tag, the processing circuitry is further configured to integrate a reference to the first tag in the second node element.

12. The overlay system of claim 1, wherein prior to the execution of the first operation, the processing circuitry is further configured to:
determine whether at least one of a group consisting of the first active node or the first tag overlay node is loaded in the executable graph-based model;
load, based on at least one of the group consisting of the first active node or the first tag overlay node being unloaded from the executable graph-based model, at least one of the group consisting of the first active node or the first tag overlay node in the executable graph-based model; and
load, based on the loading of the first active node, the first tag, in the executable graph-based model, in association with the first active node.

13. The overlay system of claim 1,
wherein based on the first active node being an edge node, the first active node is associated with a third active node and a fourth active node, with the first active node coupling the third active node and the fourth active node,
wherein, based on an absence of a tag with the first tag type being associated with at least one of a group consisting of the third active node or the fourth active node, the processing circuitry is configured to associate the first tag to at least one of the group consisting of the third active node or the fourth active node of the tag with the first tag type, and
wherein the first operation is executed further based on at least one of the group consisting of the third active node or the fourth active node, associated with the first tag.

14. The overlay system of claim 1, wherein the first tag overlay node includes a processing logic that corresponds to a functionality of the first tag overlay node.

15. The overlay system of claim 1, wherein the processing circuitry is further configured to:
receive a second stimulus associated with the overlay system;
identify, based on the second stimulus, the first active node of the plurality of active nodes;
determine, a second tag overlay node-type of a second tag overlay node, of the plurality of tag overlay nodes, associated with the first active node;
determine a fifth tag of the first set of tags, wherein the fifth tag has a second tag type that matches the second tag overlay node-type of the second tag overlay node; and
execute, in response to the second stimulus, a second operation based on the first active node and the second tag overlay node, wherein the execution of the second operation conforms with a second execution criterion indicated by the fifth tag.

16. The overlay system of claim 1, wherein the processing circuitry is further configured to:
receive a third stimulus associated with the overlay system;
identify, based on the third stimulus, a fifth active node of the plurality of active nodes;
determine the first tag overlay node-type of the first tag overlay node associated with the fifth active node;
determine a sixth tag of a second set of tags associated with the fifth active node, wherein the sixth tag has the first tag type; and
execute, in response to the third stimulus, a third operation based on the fifth active node and the first tag overlay node, wherein the execution of the third operation conforms with a third execution criterion indicated by the sixth tag.

17. The overlay system of claim 1,
wherein the executable graph-based model is a hierarchical structure,
wherein the first active node is a parent node of a sixth active node of the plurality of active nodes, and
wherein the processing circuitry is further configured to:
determine an absence of a tag with the first tag type being associated with the sixth active node; and
associate, based on the absence of the tag with the first tag type being associated with the sixth active node, the first tag with the sixth active node, wherein the first operation is executed further based on the sixth active node.

18. The overlay system of claim 1,
wherein the first active node is a run-time node including (i) a node template that corresponds to a predefined node structure, and (ii) a node instance that corresponds to an implementation of the node template, and
wherein the first tag corresponds to a run-time tag including (i) a tag template that corresponds to a predefined tag structure, and (ii) a tag instance that corresponds to an implementation of the tag template.

19. The overlay system of claim 18,
wherein the processing circuitry is further configured to load the first active node based on loading of the node template and the node instance, and
wherein, based on the loading of the first active node, the processing circuitry is further configured to load the first tag based on loading of the tag template and the tag instance of the first tag.

20. A method, comprising:
receiving, by processing circuitry, a stimulus associated with an overlay system,
wherein an executable graph-based model is stored in a storage element of the overlay system,
wherein the executable graph-based model includes a plurality of active nodes associated with a plurality of tag overlay nodes, and
wherein each active node, of the plurality of active nodes, has a set of tags associated therewith, with each tag of the set of tags indicating an execution criterion for a tag overlay node of the plurality of tag overlay nodes;
identifying, by the processing circuitry, based on the stimulus, a first active node of the plurality of active nodes;
determining, by the processing circuitry, a first tag overlay node-type of a first tag overlay node, of the plurality of tag overlay nodes, associated with the first active node;
determining, by the processing circuitry, a first tag of a first set of tags associated with the first active node, wherein the first tag has a first tag type that matches the first tag overlay node-type of the first tag overlay node; and
executing, by the processing circuitry, in response to the stimulus, a first operation based on the first active node and the first tag overlay node, wherein the execution of the first operation conforms with a first execution criterion indicated by the first tag.
